(19) United States
(12) Patent Application Publication
(10) Pub. No.: US 2025/0056567 A1
(43) Pub. Date: Feb. 13, 2025

(54) SIDELINK SYNCHRONIZATION SIGNAL BLOCK TRANSMISSION IN AN UNLICENSED BAND

(71) Applicant: QUALCOMM INCORPORATED, San Diego, CA (US)

(72) Inventors: Siyi Chen, Beijing (CN); Jing Sun, San Diego, CA (US); Xiaoxia Zhang, San Diego, CA (US); Changlong Xu, Beijing (CN); Shaozhen Guo, Beijing (CN); Luanxia Yang, Beijing (CN)

(21) Appl. No.: 18/717,968

(22) PCT Filed: Feb. 24, 2022
(86) PCT No.: PCT/CN2022/077638

§ 371 Date: Jun. 7, 2024

(51) Int. Cl. H04W 72/25; H04W 56/00

(52) U.S. Cl. CPC H04W 72/25; H04W 56/001

(57) ABSTRACT

Methods, systems, and devices for wireless communications are described. In some examples, a first UE may be configured to transmit multiple sidelink synchronization signal blocks (S-SSBs) within an S-SSB period, the transmissions back-to-back or non-back-to-back. The first UE may determine one or more listen-before-talk occasions associated with the S-SSBs, participate in at least one listen-before-talk procedure during a listen-before-talk occasion, and transmit the multiple S-SSBs to a second UE. In some other examples, the first UE may identify a reference frequency position of a reference S-SSB in a sidelink BWP. The first UE may transmit the reference S-SSB and one or more additional S-SSBs to a second UE, the one or more additional S-SSBs having frequency positions following the reference frequency position.

### CROSS REFERENCE

The present application is a 371 national stage filing of International PCT Application No. PCT/CN2022/077638 by Chen et al. entitled “SIDELINK SYNCHRONIZATION SIGNAL BLOCK TRANSMISSION IN AN UNLICENSED BAND,” filed Feb. 24, 2022, which is assigned to the assignee hereof, and which is expressly incorporated by reference in its entirety herein.

### FIELD OF TECHNOLOGY

The following relates to wireless communications, including sidelink synchronization signal block (S-SSB) transmission in an unlicensed band.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some cases, multiple UEs may perform sidelink communications, which may include sidelink synchronization signal block (S-SSB) transmissions. In some cases, signal strength of the S-SSBs and transmission success rates may be improved.

### SUMMARY

The described techniques relate to improved methods, systems, devices, and apparatuses that support sidelink synchronization signal block (S-SSB) transmission in an unlicensed band. For example, the described techniques provide for a first user equipment (UE) (e.g., a transmit UE) to transmit multiple S-SSB repetitions to increase the received signal strength of the transmissions. For example, the UE may transmit multiple S-SSB repetitions in the time domain. The first UE may receive a message from a network entity indicating that the first UE is to transmit multiple S-SSBs, back-to-back or with an offset between each S-SSB, within an S-SSB period. The first UE may determine one or more listen-before-talk (LBT) occasions, where a timing for each LBT occasion may be based on whether the S-SSBs are to be transmitted back-to-back or with the offset. In some examples, the first UE may participate in an LBT procedure during the one or more LBT occasions and transmit the multiple S-SSBs to a second UE (e.g., a receive UE). In some other examples, the first UE may transmit multiple S-SSB repetitions in the frequency domain. For example, the first UE may identify a reference position of a reference S-SSB in a sidelink bandwidth part (BWP) in frequency, and transmit the reference S-SSB and one or more additional S-SSBs to the second UE, where the frequency positions of the one or more additional S-SSBs are different from but based on the reference frequency position (e.g., following the reference frequency position).

A method for wireless communication at a first user equipment (UE) is described. The method may include receiving, from a network entity, a message indicating that the first UE is to transmit multiple S-SSBs within an S-SSB period, the message also indicative of whether the multiple S-SSBs are to be transmitted back-to-back or with an offset between consecutive ones of the multiple S-SSBs, determining one or more LBT occasions in association with the multiple S-SSBs, where a timing of the one or more LBT occasions is based on whether the multiple S-SSBs are to be transmitted back-to-back or with the offset between the consecutive ones of the multiple S-SSBs, participating in at least one LBT procedure during the one or more LBT occasions, and transmitting, to a second UE, the multiple S-SSBs.

An apparatus for wireless communication at a first UE is described. The apparatus may include a processor, memory coupled with the processor, and instructions stored in the memory. The instructions may be executable by the processor to cause the apparatus to receive, from a network entity, a message indicating that the first UE is to transmit multiple S-SSBs within an SSB period, the message also indicative of whether the multiple S-SSBs are to be transmitted back-to-back or with an offset between consecutive ones of the multiple S-SSBs, determine one or more LBT occasions in association with the multiple S-SSBs, where a timing of the one or more LBT occasions is based on whether the multiple S-SSBs are to be transmitted back-to-back or with the offset between the consecutive ones of the multiple S-SSBs, participate in at least one LBT procedure during the one or more LBT occasions, and transmit, to a second UE, the multiple S-SSBs.

Another apparatus for wireless communication at a first UE is described. The apparatus may include means for receiving, from a network entity, a message indicating that the first UE is to transmit multiple S-SSBs within an S-SSB period, the message also indicative of whether the multiple S-SSBs are to be transmitted back-to-back or with an offset between consecutive ones of the multiple S-SSBs, means for determining one or more LBT occasions in association with the multiple S-SSBs, where a timing of the one or more LBT occasions is based on whether the multiple S-SSBs are to be transmitted back-to-back or with the offset between the consecutive ones of the multiple S-SSBs, means for participating in at least one LBT procedure during the one or more LBT occasions, and means for transmitting, to a second UE, the multiple S-SSBs.

A non-transitory computer-readable medium storing code for wireless communication at a first UE is described. The code may include instructions executable by a processor to receive, from a network entity, a message indicating that the first UE is to transmit multiple S-SSBs within an S-SSB period, the message also indicative of whether the multiple S-SSBs are to be transmitted back-to-back or with an offset between consecutive ones of the multiple S-SSBs, determine one or more LBT occasions in association with the multiple S-SSBs, where a timing of the one or more LBT occasions is based on whether the multiple S-SSBs are to be transmitted back-to-back or with the offset between the consecutive ones of the multiple S-SSBs, participate in at least one LBT procedure during the one or more LBT occasions, and transmit, to a second UE, the multiple S-SSBs.

In some examples of the method, apparatuses, and non-transitory computer-readable medium described herein, receiving the message indicating that the first UE may be to transmit multiple S-SSBs within the S-SSB period may include operations, features, means, or instructions for receiving an indication of a sidelink configuration, the sidelink configuration indicating that the first UE may be to transmit the multiple S-SSBs within an S-SSB instance of the S-SSB period.

Some examples of the method, apparatuses, and non-transitory computer-readable medium described herein may further include operations, features, means, or instructions for determining, based at least on a radio resource control (RRC) parameter of the sidelink configuration, a determined quantity of the multiple S-SSBs for inclusion within the S-SSB instance.

In some examples of the method, apparatuses, and non-transitory computer-readable medium described herein, the sidelink configuration defines an interval between starting times of consecutive S-SSB instances, where the interval allows for the multiple S-SSBs to be included within a first S-SSB instance without overlapping a second S-SSB instance of the consecutive S-SSB instances.

In some examples of the method, apparatuses, and non-transitory computer-readable medium described herein, the sidelink configuration indicating that the multiple S-SSBs may be to transmitted within the S-SSB instance may be indicative that the multiple S-SSBs is to be transmitted back-to-back.

In some examples of the method, apparatuses, and non-transitory computer-readable medium described herein, receiving the message indicating that the first UE may be to transmit multiple S-SSBs within the S-SSB period may include operations, features, means, or instructions for receiving an indication of a sidelink configuration, the sidelink configuration indicating that the first UE may be to transmit the multiple S-SSBs within a corresponding multiple S-SSB instances of the S-SSB period.

In some examples of the method, apparatuses, and non-transitory computer-readable medium described herein, transmitting the multiple S-SSBs may include operations, features, means, or instructions for transmitting the multiple S-SSBs back-to-back within the S-SSB period.

In some examples of the method, apparatuses, and non-transitory computer-readable medium described herein, determining the one or more LBT occasions may include operations, features, means, or instructions for identifying a first LBT occasion associated with a temporally first of the multiple S-SSBs, where the at least one LBT occasion during which the first UE participates in the listen-to-talk procedure may be the first LBT occasion, the transmitting of the multiple S-SSBs based on the first UE participating in the LBT procedure during only the first LBT occasion.

In some examples of the method, apparatuses, and non-transitory computer-readable medium described herein, determining the one or more LBT occasions may include operations, features, means, or instructions for identifying a first LBT occasion associated with a temporally first of the multiple S-SSBs, where the first UE participates in an unsuccessful LBT procedure during the first LBT occasion and identifying one or more additional LBT occasions that temporally follow the first LBT occasion, where the at least one LBT occasion during which the first UE participates in the listen-to-talk procedure includes one of the one or more additional LBT occasions after also participating in the unsuccessful LBT procedure.

Some examples of the method, apparatuses, and non-transitory computer-readable medium described herein may further include operations, features, means, or instructions for determining, based on the message, a quantity of the multiple S-SSBs for transmission, where less than the quantity may be transmitted based on the first UE participating in the unsuccessful LBT procedure during the first LBT occasion.

Some examples of the method, apparatuses, and non-transitory computer-readable medium described herein may further include operations, features, means, or instructions for determining that one or more automatic gain control (AGC) or gap symbols may be during a transmission interval for the multiple S-SSBs and transmitting a sidelink broadcast channel during the one or more AGC or gap symbols based on the multiple S-SSBs being transmitted back-to-back.

In some examples of the method, apparatuses, and non-transitory computer-readable medium described herein, transmitting the sidelink broadcast channel may include operations, features, means, or instructions for transmitting the sidelink broadcast channel during a gap symbol by including resource elements of the gap symbol in rate matching or by duplicating a previously transmitted sidelink broadcast channel.

In some examples of the method, apparatuses, and non-transitory computer-readable medium described herein, transmitting the multiple S-SSBs may include operations, features, means, or instructions for transmitting the multiple S-SSBs with the offset between consecutive ones of the multiple S-SSBs.

In some examples of the method, apparatuses, and non-transitory computer-readable medium described herein, determining the one or more LBT occasions may include operations, features, means, or instructions for identifying a set of multiple LBT occasions, each associated with one of the multiple S-SSBs, the transmitting of the multiple S-SSBs based on the first UE participating in the LBT procedure during multiple ones of the set of multiple LBT occasions.

Some examples of the method, apparatuses, and non-transitory computer-readable medium described herein may further include operations, features, means, or instructions for extending a first bandwidth of a primary synchronization signal (PSS) of an S-SSB, a second bandwidth of a secondary synchronization signal (SSS) of one or more of the multiple S-SSBs, and a third bandwidth of a sidelink broadcast channel of the S-SSB within a sidelink BWP based on lowering a coding rate, increasing a payload size, or both.

Some examples of the method, apparatuses, and non-transitory computer-readable medium described herein may further include operations, features, means, or instructions for determining a power for transmitting the one or more S-SSBs or a sidelink broadcast channel based on a quantity of resource blocks for transmitting the one or more S-SSBs or the sidelink broadcast channel for an identified sub-carrier spacing configuration.

A method for wireless communication at a first UE is described. The method may include identifying, via a message, that a second UE is to transmit multiple S-SSBs within an S-SSB period, the message also indicative of whether the multiple S-SSBs are to be transmitted back-to-back or with an offset between consecutive ones of the multiple S-SSBs, monitoring for the multiple S-SSBs transmitted by the second UE in accordance with the message, and receiving, from the second UE, at least one of the multiple S-SSBs.

An apparatus for wireless communication at a first UE is described. The apparatus may include a processor, memory coupled with the processor, and instructions stored in the memory. The instructions may be executable by the processor to cause the apparatus to identify, via a message, that a second UE is to transmit multiple S-SSBs within an S-SSB period, the message also indicative of whether the multiple S-SSBs are to be transmitted back-to-back or with an offset between consecutive ones of the multiple S-SSBs, monitor for the multiple S-SSBs transmitted by the second UE in accordance with the message, and receive, from the second UE, at least one of the multiple S-SSBs.

Another apparatus for wireless communication at a first UE is described. The apparatus may include means for identifying, via a message, that a second UE is to transmit multiple S-SSBs within an S-SSB period, the message also indicative of whether the multiple S-SSBs are to be transmitted back-to-back or with an offset between consecutive ones of the multiple S-SSBs, means for monitoring for the multiple S-SSBs transmitted by the second UE in accordance with the message, and means for receiving, from the second UE, at least one of the multiple S-SSBs.

A non-transitory computer-readable medium storing code for wireless communication at a first UE is described. The code may include instructions executable by a processor to identify, via a message, that a second UE is to transmit multiple S-SSBs within an S-SSB period, the message also indicative of whether the multiple S-SSBs are to be transmitted back-to-back or with an offset between consecutive ones of the multiple S-SSBs, monitor for the multiple S-SSBs transmitted by the second UE in accordance with the message, and receive, from the second UE, at least one of the multiple S-SSBs.

In some examples of the method, apparatuses, and non-transitory computer-readable medium described herein, identifying that the second UE may be to transmit multiple S-SSBs within the S-SSB period may include operations, features, means, or instructions for receiving an indication of a sidelink configuration, the sidelink configuration indicating that the second UE may be to transmit the multiple S-SSBs within an S-SSB instance of the S-SSB period.

In some examples of the method, apparatuses, and non-transitory computer-readable medium described herein, the sidelink configuration defines an interval between starting times of consecutive S-SSB instances, where the interval allows for the multiple S-SSBs to be included within a first S-SSB instance without overlapping a second S-SSB instance of the consecutive S-SSB instances.

In some examples of the method, apparatuses, and non-transitory computer-readable medium described herein, the sidelink configuration indicating that the multiple S-SSBs may be to transmitted within the S-SSB instance may be indicative that the multiple S-SSBs is to be transmitted back-to-back.

In some examples of the method, apparatuses, and non-transitory computer-readable medium described herein, identifying that the second UE may be to transmit multiple S-SSBs within the S-SSB period may include operations, features, means, or instructions for receiving an indication of a sidelink configuration, the sidelink configuration indicating that the second UE may be to transmit the multiple S-SSBs within a corresponding multiple S-SSB instances of the S-SSB period.

In some examples of the method, apparatuses, and non-transitory computer-readable medium described herein, receiving at least one of the multiple S-SSBs may include operations, features, means, or instructions for receiving a set of multiple the multiple S-SSBs back-to-back within the S-SSB period.

Some examples of the method, apparatuses, and non-transitory computer-readable medium described herein may further include operations, features, means, or instructions for receiving a sidelink broadcast channel during one or more AGC or gap symbols based on the multiple S-SSBs being received back-to-back.

In some examples of the method, apparatuses, and non-transitory computer-readable medium described herein, receiving at least one of the multiple S-SSBs may include operations, features, means, or instructions for receiving a set of multiple the multiple S-SSBs with the offset between consecutive ones of the multiple S-SSBs.

In some examples of the method, apparatuses, and non-transitory computer-readable medium described herein, receiving at least one of the multiple S-SSBs may include operations, features, means, or instructions for blind detecting for the multiple S-SSBs and determining that a received signal may be one of the multiple S-SSBs based on a comparison of a correlation energy of the received signal with a threshold.

A method for wireless communication at a first UE is described. The method may include identifying a reference frequency position of a reference S-SSB in a sidelink BWP, transmitting, to a second UE, the reference S-SSB in accordance with the reference frequency position, and transmitting, to the second UE, one or more additional S-SSBs whose frequency positions are different from but based on the reference frequency position.

An apparatus for wireless communication at a first UE is described. The apparatus may include a processor, memory coupled with the processor, and instructions stored in the memory. The instructions may be executable by the processor to cause the apparatus to identify a reference frequency position of a reference S-SSB in a sidelink BWP, transmit, to a second UE, the reference S-SSB in accordance with the reference frequency position, and transmit, to the second UE, one or more additional S-SSBs whose frequency positions are different from but based on the reference frequency position.

Another apparatus for wireless communication at a first UE is described. The apparatus may include means for identifying a reference frequency position of a reference S-SSB in a sidelink BWP, means for transmitting, to a second UE, the reference S-SSB in accordance with the reference frequency position, and means for transmitting, to the second UE, one or more additional S-SSBs whose frequency positions are different from but based on the reference frequency position.

A non-transitory computer-readable medium storing code for wireless communication at a first UE is described. The code may include instructions executable by a processor to identify a reference frequency position of a reference S-SSB in a sidelink BWP, transmit, to a second UE, the reference S-SSB in accordance with the reference frequency position, and transmit, to the second UE, one or more additional S-SSBs whose frequency positions are different from but based on the reference frequency position.

Some examples of the method, apparatuses, and non-transitory computer-readable medium described herein may further include operations, features, means, or instructions for receiving, from a network entity, a message indicating the reference frequency position of the reference S-SSB in the sidelink BWP.

In some examples of the method, apparatuses, and non-transitory computer-readable medium described herein, transmitting the one or more additional S-SSBs may include operations, features, means, or instructions for transmitting the one or more additional S-SSBs whose frequency positions may be different from but based on the reference frequency position, where the one or more additional S-SSBs may be continuous in frequency.

Some examples of the method, apparatuses, and non-transitory computer-readable medium described herein may further include operations, features, means, or instructions for receiving, from a network entity, signaling indicating a sub-carrier spacing configuration, the sub-carrier spacing configuration indicative of a quantity of S-SSBs to be transmitted in the sidelink BWP by the first UE, the S-SSBs including the reference S-SSB and the one or more additional S-SSBs and identifying the quantity of S-SSBs to be transmitted in the sidelink BWP by the first UE based on receiving the signaling.

Some examples of the method, apparatuses, and non-transitory computer-readable medium described herein may further include operations, features, means, or instructions for receiving, from a network entity, signaling indicating a quantity of S-SSBs to be transmitted in the sidelink BWP by the first UE, the S-SSBs including the reference S-SSB and the one or more additional S-SSBs.

Some examples of the method, apparatuses, and non-transitory computer-readable medium described herein may further include operations, features, means, or instructions for identifying a quantity of S-SSBs to be transmitted in the sidelink BWP by the first UE, where the quantity of S-SSBs may be pre-configured, and where the S-SSBs include the reference S-SSB and the one or more additional S-SSBs.

In some examples of the method, apparatuses, and non-transitory computer-readable medium described herein, transmitting the one or more additional S-SSBs may include operations, features, means, or instructions for transmitting the one or more additional S-SSBs whose frequency positions may be different from but based on the reference frequency position, where the one or more additional S-SSBs may be at least partially discontinuous in frequency.

In some examples of the method, apparatuses, and non-transitory computer-readable medium described herein, a quantity of S-SSBs may be based on a mode of the first UE, where the mode includes a low power indoor mode or a very low power mode, and where the S-SSBs include the reference S-SSBs and the one or more additional S-SSBs.

Some examples of the method, apparatuses, and non-transitory computer-readable medium described herein may further include operations, features, means, or instructions for receiving, from a network entity, signaling indicating a bitmap indicative of a quantity of S-SSBs to be transmitted in the sidelink BWP by the first UE, the S-SSBs including the reference S-SSB and the one or more additional S-SSBs, and where a first bit of the bitmap corresponds to the reference S-SSB.

Some examples of the method, apparatuses, and non-transitory computer-readable medium described herein may further include operations, features, means, or instructions for extending a first bandwidth of a PSS of an S-SSB, a second bandwidth of an SSS of one or more multiple S-SSBs, and a third bandwidth of a sidelink broadcast channel of the S-SSB within a sidelink BWP based on lowering a coding rate, increasing a payload size, or both.

Some examples of the method, apparatuses, and non-transitory computer-readable medium described herein may further include operations, features, means, or instructions for determining a power for transmitting an S-SSB or a sidelink broadcast channel based on a quantity of resource blocks for transmitting the S-SSB or the sidelink broadcast channel with a sub-carrier spacing configuration.

A method for wireless communication at a first UE is described. The method may include identifying a reference frequency position of a reference S-SSB in a sidelink BWP, receiving, from a second UE, the reference S-SSB in accordance with the reference frequency position, and receiving, from the second UE, one or more additional S-SSBs whose frequency positions are different from but based on the reference frequency position.

An apparatus for wireless communication at a first UE is described. The apparatus may include a processor, memory coupled with the processor, and instructions stored in the memory. The instructions may be executable by the processor to cause the apparatus to identify a reference frequency position of a reference S-SSB in a sidelink BWP, receive, from a second UE, the reference S-SSB in accordance with the reference frequency position, and receive, from the second UE, one or more additional S-SSBs whose frequency positions are different from but based on the reference frequency position.

Another apparatus for wireless communication at a first UE is described. The apparatus may include means for identifying a reference frequency position of a reference S-SSB in a sidelink BWP, means for receiving, from a second UE, the reference S-SSB in accordance with the reference frequency position, and means for receiving, from the second UE, one or more additional S-SSBs whose frequency positions are different from but based on the reference frequency position.

A non-transitory computer-readable medium storing code for wireless communication at a first UE is described. The code may include instructions executable by a processor to identify a reference frequency position of a reference S-SSB in a sidelink BWP, receive, from a second UE, the reference S-SSB in accordance with the reference frequency position, and receive, from the second UE, one or more additional S-SSBs whose frequency positions are different from but based on the reference frequency position.

Some examples of the method, apparatuses, and non-transitory computer-readable medium described herein may further include operations, features, means, or instructions for receiving, from a network entity, a message indicating the reference frequency position of the reference S-SSB in the sidelink BWP.

In some examples of the method, apparatuses, and non-transitory computer-readable medium described herein, receiving the one or more additional S-SSBs may include operations, features, means, or instructions for receiving the one or more additional S-SSBs whose frequency positions may be different from but based on the reference frequency position, where the one or more additional S-SSBs may be continuous in frequency.

Some examples of the method, apparatuses, and non-transitory computer-readable medium described herein may further include operations, features, means, or instructions for decoding the one or more additional S-SSBs to identify pseudo-noise sequence-based scrambling added to each S-SSB of the one or more additional S-SSBs, where a pseudo-noise sequence of the pseudo-noise sequence-based scrambling may be different for each S-SSB of the one or more additional S-SSBs.

In some examples of the method, apparatuses, and non-transitory computer-readable medium described herein, receiving the one or more additional S-SSBs may include operations, features, means, or instructions for receiving the one or more additional S-SSBs whose frequency positions may be different from but based on the reference frequency position, where the one or more additional S-SSBs may be at least partially discontinuous in frequency.

In some examples of the method, apparatuses, and non-transitory computer-readable medium described herein, a quantity of S-SSBs may be based on a mode of the first UE, where the mode includes a low power indoor mode or a very low power mode, and where the S-SSBs include the reference S-SSBs and the one or more additional S-SSBs.

### BRIEF DESCRIPTION OF THE DRAWINGS

FIG. 1 illustrates an example of a wireless communications system that supports sidelink synchronization signal block (S-SSB) transmission in an unlicensed band in accordance with one or more aspects of the present disclosure.

FIG. 2 illustrates an example of a wireless communications system that supports S-SSB transmission in an unlicensed band in accordance with one or more aspects of the present disclosure.

FIG. 3 through 9 illustrate examples of S-SSB repetition schemes that support S-SSB transmission in an unlicensed band in accordance with one or more aspects of the present disclosure.

FIG. 10 illustrates an example of an S-SSB that supports S-SSB transmission in an unlicensed band in accordance with one or more aspects of the present disclosure.

FIGS. 11 and 12 illustrate examples of process flows that support S-SSB transmission in an unlicensed band in accordance with one or more aspects of the present disclosure.

FIGS. 13 and 14 show block diagrams of devices that support S-SSB transmission in an unlicensed band in accordance with one or more aspects of the present disclosure.

FIG. 15 shows a block diagram of a communications manager that supports S-SSB transmission in an unlicensed band in accordance with one or more aspects of the present disclosure.

FIG. 16 shows a diagram of a system including a device that supports S-SSB transmission in an unlicensed band in accordance with one or more aspects of the present disclosure.

FIGS. 17 through 26 show flowcharts illustrating methods that support S-SSB transmission in an unlicensed band in accordance with one or more aspects of the present disclosure.

### DETAILED DESCRIPTION

In some wireless communications systems, a user equipment (UE) may perform sidelink communications in an unlicensed band. The UE, if operating in a low power indoor (LPI) mode or a very low power (VLP) mode in an unlicensed, 6 GHz band, may have power spectral density (PSD) and effective isotropic radiated power (EIRP) limitations. For example, a UE operating in the LPI mode in a 6 GHz band may be limited to a PSD of −1 dBm per MHz and a maximum EIRP of 24 dBm. As a result, the UE may transmit 320 MHz to reach the peak power. However, if the UE uses a sidelink synchronization signal block (S-SSB) with a particular bandwidth for sidelink communications in an unlicensed band, the transmit power may be very small such that receiving UEs may be unable to successfully decode the transmissions. In addition, a UE operating in the VLP mode in the 6 GHz band may be limited to a PSD of approximately −18 dBm to −8 dBm per MHz and a maximum EIRP of approximately 4 dBm to 14 dBm, which may cause the UE 115 to transmit 160 MHz to reach the peak power. As a result, the signal strength of transmitted S-SSBs may decrease, causing receiving UEs to increasingly fail to decode the transmissions.

Techniques described herein enable UEs to transmit S-SSBs in an unlicensed band to support improved sidelink communications. In some examples, a first UE (e.g., a transmit UE) may transmit multiple S-SSB repetitions in the time domain to increase the received signal strength of the transmissions. For example, the first UE may receive a message from a network entity indicating that the first UE is to transmit multiple S-SSBs, back-to-back or with an offset between each S-SSB, within an S-SSB period. The first UE may determine one or more listen-before-talk (LBT) occasions, where a timing for each LBT occasion may be based on whether the S-SSBs are to be transmitted back-to-back or with the offset. In some examples, the first UE may participate in an LBT procedure during the one or more LBT occasions and transmit the multiple S-SSBs to a second UE (e.g., a receive UE). In some other examples, the first UE may transmit multiple S-SSB repetitions in the frequency domain. For example, the first UE may identify a reference position of a reference S-SSB in a sidelink bandwidth part (BWP) in frequency, and transmit the reference S-SSB and one or more additional S-SSBs to the second UE, where the frequency positions of the one or more additional S-SSBs are different from but based on the reference frequency position (e.g., following the reference frequency position).

In some cases, an S-SSB may include multiple synchronization signals, including at least one of a sidelink primary synchronization signal (S-PSS), a sidelink secondary synchronization signal (S-SSS), a physical sidelink broadcast channel (PSBCH), or any combination thereof. To support a wideband S-SSB, the bandwidth of the at least one S-PSS, the at least one S-SSS, and the at least one PSBCH may be extended to span more resource blocks within the sidelink BWP. Additionally, or alternatively, the transmitting UE may determine a power of an S-SSB transmission or a PSBCH transmission based on a quantity of resource blocks for the transmission for a particular sub-carrier spacing (SCS).

Aspects of the disclosure are initially described in the context of wireless communications systems. Aspects of the disclosure are then described in the context of S-SSB repetition schemes, S-SSBs, and process flows. Aspects of the disclosure are further illustrated by and described with reference to apparatus diagrams, system diagrams, and flowcharts that relate to S-SSB transmission in an unlicensed band.

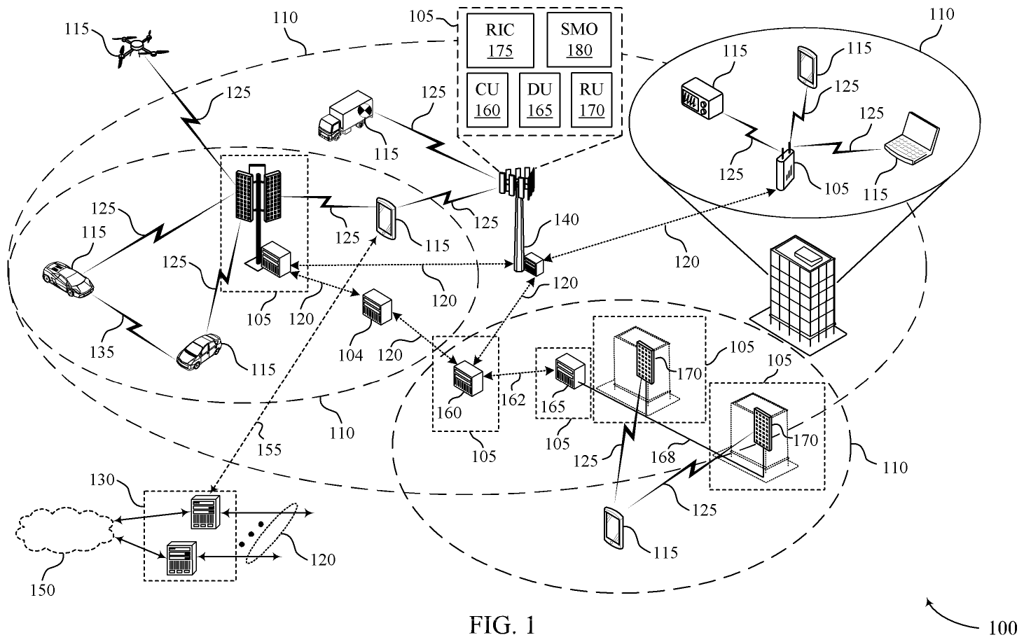

FIG. 1 illustrates an example of a wireless communications system 100 that supports S-SSB transmission in an unlicensed band in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In some examples, network entities 105 and UEs 115 may wirelessly communicate via one or more communication links 125. For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, anode of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an access point, a radio transceiver, a NodeB, an eNodeB (eNB), a next-generation NodeB or a giga-NodeB (either of which may be referred to as a gNB), a next-generation eNB (ng-eNB), a Home NodeB, a Home eNodeB, or other suitable terminology). A network entity 105 (e.g., a base station 140) may be implemented in an aggregated or monolithic base station architecture, or alternatively, in a disaggregated base station architecture. For example, a network entity 105 may include one or more of a central unit (CU) 160, a distributed unit (DU) 165, a radio unit (RU) 170, a Radio Access Network (RAN) Intelligent Controller (RIC) 175 (e.g., a Near-Real Time RIC (Near-RT RIC), a Non-Real Time RIC (Non-RT RIC), a Service Management and Orchestration (SMO) 180 system, or any combination thereof. An RU 170 may also be referred to as a radio head, a smart radio head, a remote radio head (RRH), a remote radio unit (RRU), or a transmission/reception point (TRP). One or more components of the network entities 105 of a disaggregated RAN may be co-located, or one or more components of the network entities 105 may be located in distributed locations.

The split of functionality between a CU 160, a DU 165, and an RU 175 is flexible and may support different functionalities depending upon which functions (e.g., network layer functions, protocol layer functions, baseband functions, radio frequency functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an integrated access backhaul (IAB) network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 (e.g., one or more RUs 170) may be partially controlled by CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a BWP) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the radio frequency spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing (SCS) may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of a radio frequency spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include an SCS (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported SCS, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on SCS. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the SCS or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed radio frequency spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some wireless communications systems 100, a UE 115 may transmit sidelink communication in an unlicensed band, which may include a 5 GHz band and a 6 GHz band (e.g., an expanded unlicensed use of the 6 GHz band). Multiple UEs 115 in the wireless communications system 100 may perform sidelink communications by transmitting S-SSBs. A bandwidth of an SSB may have a bandwidth spanning 11 physical resource blocks (PRBs) which include a combination of PSBCHs, S-PSSs, S-SSSs, and demodulation reference signals (DMRSs). For example, the S-SSB may include 11 PRBs and 9 OFDM symbols for a normal cyclic prefix (NCP) or 7 OFDM symbols for an extended cyclic prefix (ECP), where a first PSBCH symbol may be used for automatic gain control (AGC) training at a receiving UE 115. A PSBCH may include 56 payload bits which include bits for a direct frame number (DFN) (e.g., 10 bits), an indication of a TDD configuration (e.g., 12 bits, which may include system-wide information including a TDD-uplink-downlink common configuration, potential sidelink slots, or both), a slot index (e.g., 7 bits), an in-coverage indicator (e.g., 1 bit), reserve bits (e.g., 2 bits), and a CRC (e.g., 24 bits). In addition, the S-SSB may include S-PSSs, which may span a bandwidth of 127 (e.g., a maximum-length sequence) PRBs, have a same generator or initial value as some Uu PSSs (e.g., with cyclic shifts of 22 and 65), and be repeated on two consecutive symbols. The S-SSB may also include S-SSSs, which may span a bandwidth of 127 (e.g., a Gold-code sequence), have a same generator or initial value and same cyclic shifts as Uu SSSs, and be repeated on two consecutive symbols. Additionally, the S-SSB may include a DMRS in each PSBCH symbol and each fourth resource element, and the last symbol of the S-SSB may include a gap symbol.

In some examples, a UE 115 may transmit an S-SSB with a periodicity of 160 ms for any SCS. A network entity may configure a quantity of S-SSBs that UEs 115 may transmit within a period (e.g., 160 ms) for a given SCS. For example, in frequency range 1 (FR1), the UE 115 may transmit 1 S-SSB in a period for a 15 kHz SCS, 1 or 2 S-SSBs in a period for a 30 kHz SCS, and 1, 2, or 4 S-SSBs in a period for a 60 kHz SCS. In frequency range 2 (FR2), the UE 115 may transmit up to 32 S-SSBs (e.g., 1, 2, 4, 8, 16, or 32 S-SSBs) in a period for a 60 kHz SCS, and up to 64 S-SSBs (e.g., 1, 2, 4, 8, 16, 32, or 64 S-SSBs) in a period for a 120 kHz SCS. In some examples, a transmit UE 115 may transmit an S-SSB to a receive UE 115 (e.g., in sidelink communications with the transmit UE 115) to perform a synchronization procedure.

Additionally, or alternatively, a UE 115 may determine a power for an S-SSB or a PSBCH transmission occasion in a slot. The power may be based on a fixed quantity of PRBs (e.g., 11 PRBs) used for the S-SSB or PSBCH transmission, with a given SCS configuration p. In addition, Point A may serve as a common reference point for resource block grids, where a center of a subcarrier 0 of a common resource block 0 for the SCS configuration μ may coincide with Point A. That is, Point A may be located at the center of the common resource block 0.

In some examples, because of PSD and EIRP limitations on a UE 115 in the 6 GHz band, the UE 115 may fail to reach a maximum power for a 20 MHz transmission in an LPI mode or a VLP mode. For example, a UE 115 operating in the LPI mode in a 6 GHz band may be limited to a PSD of −1 dBm per MHz and a maximum EIRP of 24 dBm, where the PSD (when converted to a linear value), multiplied by the bandwidth, results in the EIRP. As a result, the UE 115 may transmit 320 MHz to reach the peak power. However if the UE 115 uses the S-SSB structure of an 11 PRB bandwidth for sidelink communications in an unlicensed band, as described above, the transmit power may be very small such that receiving UEs 115 may be unable to successfully decode the transmissions. In addition, a UE 115 operating in the VLP mode in the 6 GHz band may be limited to a PSD of approximately −18 dBm to −8 dBm per MHz and a maximum EIRP of approximately 4 dBm to 14 dBm, which may cause the UE 115 to transmit 160 MHz to reach the peak power.

The wireless communications system 100 supports techniques that enable UEs 115 to transmit S-SSBs in an unlicensed band to support improved sidelink communications. In some examples, a first UE 115 (e.g., a transmit UE 115) may transmit multiple S-SSB repetitions in the time domain to increase the received signal strength of the transmissions. For example, the first UE 115 may receive a message from a network entity 105 indicating that the first UE 115 is to transmit multiple S-SSBs, back-to-back or with an offset between each S-SSB, within an S-SSB period. The first UE 115 may determine one or more LBT occasions, where a timing for each LBT occasion may be based on whether the S-SSBs are to be transmitted back-to-back or with the offset. In some examples, the first UE 115 may participate in an LBT procedure during the one or more LBT occasions and transmit the multiple S-SSBs to a second UE 115 (e.g., a receive UE 115). In some other examples, the first UE 115 may transmit multiple S-SSB repetitions in the frequency domain. For example, the first UE 115 may identify a reference position of a reference S-SSB in a sidelink BWP in frequency, and transmit the reference S-SSB and one or more additional S-SSBs to the second UE 115, where the frequency positions of the one or more additional S-SSBs are different from but based on the reference frequency position (e.g., following the reference frequency position). Accordingly, the transmit UE 115 may transmit S-SSBs with an increased signal strength, which may improve a success rate of the S-SSB transmissions.

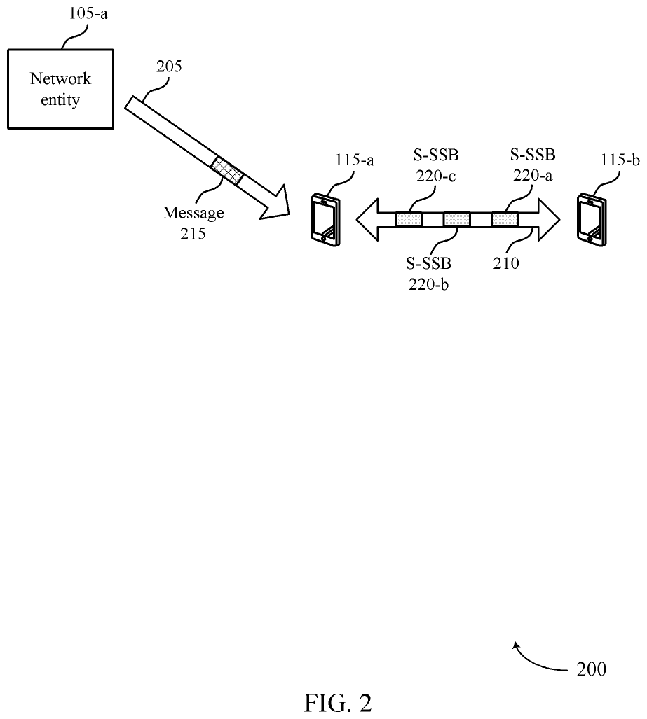

FIG. 2 illustrates an example of a wireless communications system 200 that supports S-SSB transmission in an unlicensed band in accordance with one or more aspects of the present disclosure. In some examples, the wireless communications system 200 may implement aspects of the wireless communications system 100 or may be implemented by aspects of the wireless communications system 100. For example, the wireless communications system 200 may include a network entity 105-a, a UE 115-a, and a UE 115-b, which may be examples of corresponding devices described herein.

In some examples, the network entity 105-a (e.g., a base station, a gNB) may communicate with the UE 115-a via a communications link 205 (e.g., a downlink), and the UE 115-a may communicate with the UE 115-b via a sidelink link 210. In some examples, the UE 115-a and the UE 115-b may operate in an unlicensed band (e.g., a 6 GHz band). As described herein, the UE 115-a (e.g., a transmit UE) may transmit multiple S-SSB 220 repetitions to the UE 115-b (e.g., a receive UE) in the time domain or the frequency domain such that the signal strength of an S-SSB 220 and the success rate of the S-SSB transmission may be improved.

In some cases, the UE 115-a may transmit repetitions of the S-SSBs 220 to the UE 115-b in the time domain. The UE 115-a may receive a message 215 from the network entity 105-a indicating that the UE 115-a is to transmit the S-SSBs 220 within an S-SSB period to the UE 115-b, for example, in multiple slots. The UE 115-a may transmit the S-SSBs 220 back-to-back or non-back-to-back (e.g., with an offset between consecutive S-SSBs 220). In some examples, the UE 115-a may perform an LBT procedure before transmitting the S-SSBs 220 to the UE 115-b. To do so, the UE 115-a may determine one or more LBT occasions in association with the S-SSBs 220, where a timing of an LBT procedure is based on whether the S-SSBs 220 are to be transmitted back-to-back or non-back-to-back.

In some examples, the UE 115-a may participate in an LBT procedure during one or more LBT occasions. For example, the UE 115-a may participate in a successful LBT procedure during a first LBT occasion before transmitting a first S-SSB 220 (e.g., an S-SSB 220-a). If the LBT procedure fails during the first LBT occasion, the UE 115-a may participate in the LBT procedure in one or more additional LBT occasions until the LBT procedure is successful. Following a successful LBT procedure, the UE 115-a may transmit at least one of the S-SSB 220-a, an S-SSB 220-b, and an S-SSB 220-c the UE 115-b. For example, if the LBT procedure is successful in the first LBT occasion, the UE 115-a may transmit the S-SSB 220-a, the S-SSB 220-b, the S-SSB 220-c, and any other UEs 115 scheduled to be transmitted within the S-SSB period. If the LBT procedure initially fails in one or more LBT occasions, the UE 115-a may transmit fewer LBTs than a quantity initially indicated by the network entity in the message 215.

In some examples, the UE 115-b may perform a blind detection procedure for the S-SSBs 220 transmitted by the UE 115-a. For example, the UE 115-b may determine that a received signal is one of the S-SSB 220-a, the S-SSB 220-b, or the S-SSB 220-c based on a comparison of a correlation energy of the received signal with a threshold. If the correlation energy exceeds a threshold, then the UE 115-b may detect a valid S-SSB.

In some cases, the UE 115-a may perform S-SSB repetitions in the frequency domain (e.g., in one resource block set). For example, the UE 115-a may identify a reference frequency position of a reference S-SSB in a sidelink BWP. In some examples, the reference S-SSB may be the S-SSB 220-a. The UE 115-a may transmit the S-SSB 220-a (e.g., the reference S-SSB) to the UE 115-b via the sidelink link 210 in accordance with the reference frequency position. That is, the UE 115-a may transmit the reference S-SSB at the beginning of the sidelink BWP. In some cases, the UE 115-a may receive the message 215 from the network entity 105-a, which may indicate the reference frequency position. In some examples, the UE 115-a may transmit one or more additional S-SSBs 220 (e.g., the S-SSB 220-b and the S-SSB 220-c) to the UE 115-a, where the frequency positions of the one or more additional S-SSBs 220 may be different from but based on the reference frequency position of the S-SSB 220-a. That is, the UE 115-a may transmit the S-SSB 220-b and the S-SSB 220-c after the S-SSB 220-a, where the S-SSB 220-b and the S-SSB 220-c (e.g., and any other additional S-SSBs 220) may be continuous or discontinuous in the frequency band.

In some cases, the UEs 115 may extend a bandwidth of an S-PSS, an S-SSS, a PSBCH, or any combination thereof (e.g., in the frequency domain) to support a wideband S-SSB and increase transmit power of the synchronization signals. Additionally, or alternatively, the UE 115-a may perform S-SSB or PSBCH power control based on a quantity of resource blocks used to transmit the S-SSB or the PSBCH. For example, the UE 115-a may determine a power P_{S-SSB} (i) for an S-SSB transmission or a PSBCH transmission occasion in a slot i by P_{S-SSB} (i)=min(P_{CMAX}, P_{O,S-SSB}+10 log₁₀ (2^{μ}·M_{RB}^{S-SSB})+α_{S-SSB}·PL)[dBm], where P_{CMAX} may represent a defined maximum power, P_{O,S-SSB} may represent a value of dl-P0-PSBCH (e.g., if provided, else P_{S-SSB} (i)=P_{CMAX}, α_{S-SSB} may represent a value of dl-Alpha-PSBCH (e.g., if provided, else α_{S-SSB}=1), PL may represent a value based on a particular resource block, and M_{RB}^{S-SSB} may represent a quantity of resource blocks for the S-SSB or PSBCH transmission with an SCS configuration μ. As such, the UE 115-a may determine the power for the S-SSB or PSBCH transmission based on a particular quantity of resource blocks used for the transmission with a particular SCS configuration, rather than a fixed quantity of resource blocks. In some examples, the UE 115-a may control the power in cases where the first UE transmits multiple S-SSB repetitions in the time domain or the frequency domain, or for single S-SSB transmissions.

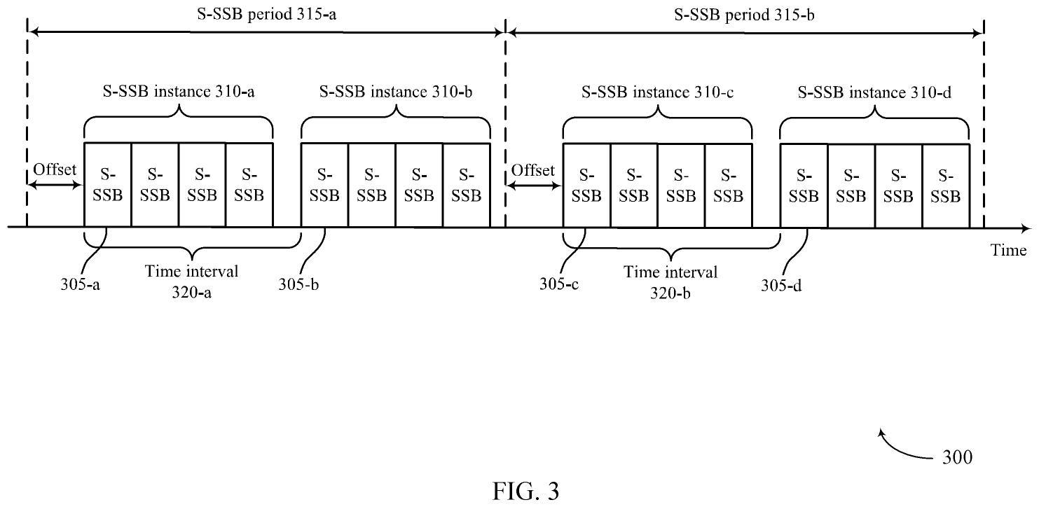

FIG. 3 illustrates an example of an S-SSB repetition scheme 300 that supports S-SSB transmission in an unlicensed band in accordance with one or more aspects of the present disclosure. In some examples, the S-SSB repetition scheme 300 may implement aspects of the wireless communications systems 100 and 200 or may be implemented by aspects of the wireless communications systems 100 and 200. For example, a first UE (e.g., a transmit UE) may transmit S-SSB repetitions to a second UE (e.g., a receive UE) in the time domain according to the S-SSB repetition scheme 300.

As described herein, the first UE and the second UE may perform sidelink communications in an unlicensed band. In some examples, the first UE may receive a message from a network entity indicating that the first UE is to transmit S-SSBs 305 (e.g., multiple S-SSB repetitions) within an S-SSB period 315 (e.g., spanning 160 ms). In some cases, the message may indicate that the first UE is transmit the repetitions of the S-SSBs 305 in the time domain (e.g., in multiple slots), for example, to increase a received signal strength of the S-SSBs 305. In some examples, the message from the network entity may include a sidelink configuration indicating that the first UE is to transmit the S-SSBs 305 within an S-SSB instance 310 of an S-SSB period 315. For example, the sidelink configuration may indicate that the first UE is to transmit four S-SSBs 305, including an S-SSB 305-a (e.g., S-SSB 0) and three other S-SSBs within an S-SSB instance 310-a of an S-SSB period 315-a, where the S-SSB period 315-a spans 160 ms. That is, the sidelink configuration may indicate that the first UE is to transmit four repetitions of the S-SSB 305-a within the S-SSB instance 310-a. In some examples, the S-SSB instance 310-a may be offset from the beginning of the S-SSB period 315-a.

In some examples, a quantity of S-SSB instances 310 within an S-SSB period 315 may remain unchanged, where the quantity of S-SSB repetitions (e.g., a repetition number) may be indicated in an RRC parameter (e.g., SL-NumRepetitionSSB in SL-SyncConfig). For example, the first UE may use the RRC parameter to indicate a quantity of S-SSBs 305 for inclusion within each S-SSB instance (e.g., a repetition number). The first UE may determine the quantity of S-SSBs 305 for inclusion within each S-SSB instance 310 based on an RRC parameter of the sidelink configuration indicated by the network entity.

In addition, a time interval 320 (e.g., sl-TimeInterval) may be configured such that the S-SSBs 305 in an S-SSB instance 310 refrain from overlapping with each other after a repetition. For example, a time interval 320-a may span the S-SSB instance 310-a plus a gap after the S-SSB instance 310-a, where the gap provides space between the S-SSB instance 310-a and the S-SSB instance 310-b to prevent the S-SSB instances 310 from overlapping with each other. Put another way, the time interval 320-a may define an interval between starting times of consecutive S-SSB instances 310, such that S-SSBs 305 may be included in each of the consecutive S-SSB instances 310 without overlapping.

In some examples, the sidelink configuration indicated by the network entity may indicate that the S-SSBs 305 in the S-SSB instances 310 are to be transmitted back-to-back. That is, the first UE may transmit the S-SSBs 305 (e.g., including the S-SSB 305-a) in the S-SSB instance 310-a back-to-back with the S-SSBs 305 (e.g., including an S-SSB 305-b) in the S-SSB instance 310-b, in accordance with the time interval 320-a and during the S-SSB period 315-a. The S-SSB instance 310-b may also include four S-SSBs 305, including the S-SSB 305-b (e.g., S-SSB 1). Additionally, the first UE may transmit the S-SSBs 305 (e.g., including an S-SSB 305-c) in the S-SSB instance 310-c back-to-back with the S-SSBs 305 (e.g., including an S-SSB 305-d) in the S-SSB instance 310-d, in accordance with a time interval 320-b and during the S-SSB period 315-b (e.g., 160 ms). The S-SSB instance 310-c may be offset from the beginning of the S-SSB period 315-b.

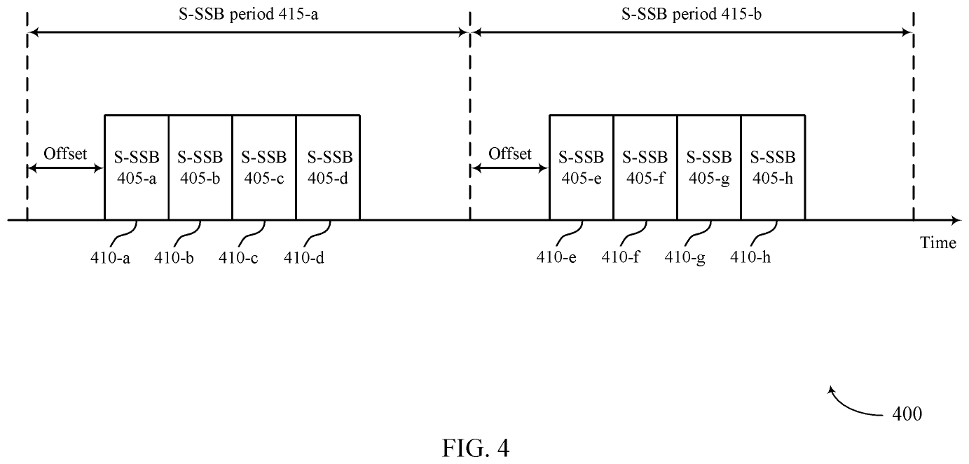

FIG. 4 illustrates an example of an S-SSB repetition scheme 400 that supports S-SSB transmission in an unlicensed band in accordance with one or more aspects of the present disclosure. In some examples, the S-SSB repetition scheme 400 may implement aspects of the wireless communications systems 100 and 200 or may be implemented by aspects of the wireless communications systems 100 and 200. For example, a first UE (e.g., a transmit UE) may transmit repetitions of S-SSBs 405 to a second UE (e.g., a receive UE) in the time domain according to the S-SSB repetition scheme 400.

In some examples, the first UE and the second UE may perform sidelink communications in an unlicensed band. In some examples, the first UE may receive a message from a network entity indicating that the first UE is to transmit S-SSBs 405 (e.g., multiple S-SSB repetitions) within an S-SSB period 415 (e.g., spanning 160 ms) in the time domain (e.g., in multiple slots). The message from the network entity may include a sidelink configuration indicating that the first UE is to transmit the S-SSBs 405 in multiple S-SSB instances 410 of an S-SSB period 415 (e.g., 160 ms). In some examples, the sidelink configuration may indicate that the first UE is to transmit four S-SSBs 405 in four corresponding S-SSB instances 410 in an S-SSB period 415-a. For example, the sidelink configuration may indicate that the first UE is to transmit an S-SSB 405-a in an S-SSB instance 410-a (e.g., an S-SSB instance 0), an S-SSB 405-b in an S-SSB instance 410-b (e.g., an S-SSB instance 1), an S-SSB 405-c in an S-SSB instance 410-c (e.g., an S-SSB instance 2), and an S-SSB 405-d in an S-SSB instance 410-d (e.g., an S-SSB instance 3) during the S-SSB period 415-a. That is, the first UE may transmit four repetitions of the S-SSBs 405 in four repeated S-SSB instances 410 during the S-SSB period 415-a (e.g., with a repetition number, K=4) back-to-back. In some other cases, the S-SSBs 405 may be transmitted non-back-to-back (e.g., with an offset between each S-SSB 405). In addition, the S-SSB instances 410 may be offset from the beginning of the S-SSB period 415-a.

In addition, the sidelink configuration may indicate that the first UE is to transmit four additional S-SSBs repetitions in four corresponding S-SSB instances 410 in an S-SSB period 415-b. For example, the sidelink configuration may indicate that the first UE is to transmit an S-SSB 405-e in an S-SSB instance 410-e (e.g., an S-SSB instance 0), an S-SSB 405-f in an S-SSB instance 410-f (e.g., an S-SSB instance 1), an S-SSB 405-g in an S-SSB instance 410-g (e.g., an S-SSB instance 2), and an S-SSB 405-h in an S-SSB instance 410-h (e.g., an S-SSB instance 3) during the S-SSB period 415-b. That is, the first UE may transmit four repetitions of the S-SSBs 405 in four repeated S-SSB instances 410 during the S-SSB period 415-b (e.g., with a repetition number, K=4) back-to-back. In some other cases, the S-SSBs 405 may be transmitted non-back-to-back (e.g., with an offset between each S-SSB 405). In addition, the S-SSB instances 410 may be offset from the beginning of the S-SSB period 415-b.

In some examples, the quantity of S-SSBs repetitions repeated in multiple S-SSB instances 410 within an S-SSB period 415 may be increased. For example, instead of transmitting a single S-SSB repetition, the first UE may transmit multiple repetitions of the S-SSBs 405 in multiple S-SSB instances 410 according to a repetition number K, which may be increased to K={1, 2, 4} for a 15 kHz SCS and to K={1, 2, 4, 8} for a 30 kHz SCS. That is, using the example in FIG. 4, the first UE may transmit up to 4 repetitions of S-SSBs 405 in the corresponding S-SSB instances 410 during the S-SSB period 415-a or the S-SSB period 415-b for a 15 kHz SCS and up to 8 repetitions of S-SSBs 405 in the corresponding S-SSB instances 410 during the S-SSB period 415-a or the S-SSB period 415-b for a 30 kHz SCS.

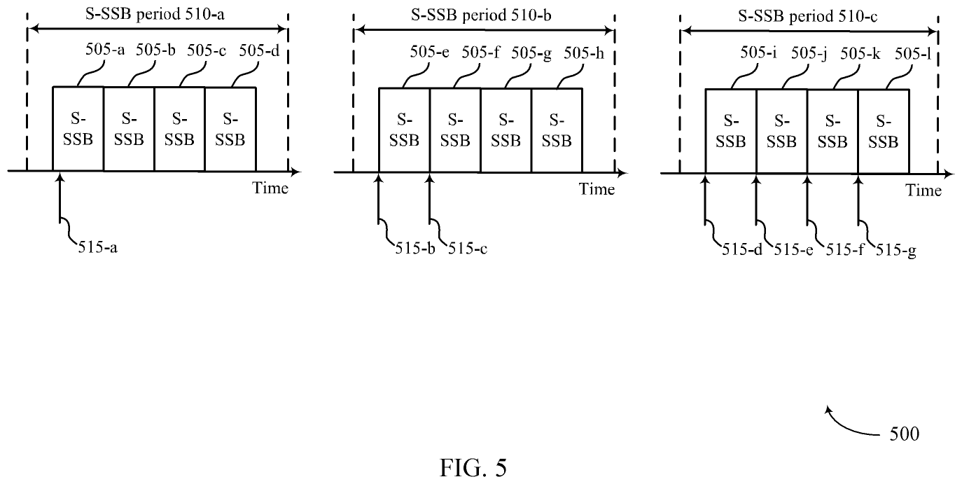

FIG. 5 illustrates an example of an S-SSB repetition scheme 500 that supports S-SSB transmission in an unlicensed band in accordance with one or more aspects of the present disclosure. In some examples, the S-SSB repetition scheme 500 may implement aspects of the wireless communications systems 100 and 200 or may be implemented by aspects of the wireless communications systems 100 and 200. For example, a first UE (e.g., a transmit UE) may transmit repetitions of an S-SSB 505 to a second UE (e.g., a receive UE) in the time domain and according to the S-SSB repetition scheme 500.

The first UE and the second UE may perform sidelink communications in an unlicensed band. In some examples, the first UE may receive a message from a network entity indicating that the first UE is to transmit multiple S-SSBs 505 (e.g., S-SSB repetitions) within an S-SSB period 510 (e.g., spanning 160 ms). In some cases, the message may indicate that the first UE is to transmit the repetitions of the S-SSBs 505 back-to-back in the time domain (e.g., in multiple slots) within an S-SSB period 510. For example, the first UE may be configured to transmit an S-SSB 505-a, an S-SSB 505-b, an S-SSB 505-c, and an S-SSB 505-d within an S-SSB period 510-a without an offset between each consecutive S-SSB 505.

The first UE may determine one or more LBT occasions 515 in association with the S-SSBs 505, where a timing of the LBT occasions 515 may be based on the first UE transmitting the S-SSBs 505 back-to-back. For example, the first UE may identify an LBT occasion 515-a (e.g., a first LBT occasion) associated with a temporally first S-SSB 505 transmitted within the S-SSB period 510-a (e.g., the S-SSB 505-a). The first UE may participate in an LBT procedure during the LBT occasion 515-a. If the LBT procedure is successful, the first UE may transmit the S-SSB 505-a, the S-SSB 505-b, the S-SSB 505-c, and the S-SSB 505-d to the second UE. As such, the first UE may refrain from performing additional LBT procedures before transmitting the S-SSB 505-b, the S-SSB 505-c, and the S-SSB 505-d.

In some cases, the first UE may perform one or more LBT procedures at different times (e.g., starting points) to prevent LBT failure, where the different times may correspond to LBT occasions 515. As the timing of the LBT occasions 515 may be based on the S-SSBs 505 being transmitted back-to-back, the LBT occasions 515 may occur before each S-SSB 505 is to be transmitted before the first UE. If an LBT procedure fails during the LBT occasion 515-a, the first UE may participate in a second LBT procedure before a different S-SSB 505. For example, the message from the network entity may indicate that the first UE is to transmit an S-SSB 505-e, an S-SSB 505-f, an S-SSB 505-g, and an S-SSB 505-h within an S-SSB period 510-b.

The first UE may identify an LBT occasion 515-b (e.g., a first LBT occasion) associated with a temporally first S-SSB 505 transmitted within the S-SSB period 510-b (e.g., the S-SSB 505-e). The first UE may participate in a first LBT procedure during the LBT occasion 515-b, which may be unsuccessful. Accordingly, the first UE may identify one or more additional LBT occasions 515 that temporally follow the LBT occasion 515-b, including an LBT occasion 515-c. The first UE may participate in an LBT procedure during the LBT occasion 515-c, and transmit the S-SSB 505-f, the S-SSB 505-g, and the S-SSB 505-h within the S-SSB period 510-b to the second UE if the LBT procedure during the LBT occasion 515-c is successful. That is, the quantity of S-SSB repetitions (e.g., repeated S-SSBs 505) transmitted by the first UE (e.g., three S-SSBs, including the S-SSB 505-f, the S-SSB 505-g, and the S-SSB 505-h) may be less than a quantity of S-SSB repetitions indicated by a network entity (e.g., the initial four S-SSBs, including the S-SSB 505-e, the S-SSB 505-f, the S-SSB 505-g, and the S-SSB 505-h). Put another way, the first UE may transmit a quantity of S-SSBs 505 that is less than the quantity indicated by the network entity based on participating in the unsuccessful LBT procedure during the LBT occasion 515-b.

In some examples, the first UE may perform an unsuccessful LBT procedure during LBT occasions 515. For example, message from the network entity may indicate that the first UE is to transmit an S-SSB 505-i, an S-SSB 505-j, an S-SSB 505-k, and an S-SSB 505-l within an S-SSB period 510-c. The first UE may identify an LBT occasion 515-d (e.g., a first LBT occasion) associated with a temporally first S-SSB 505 within the S-SSB period 510-c (e.g., the S-SSB 505-i). The first UE may participate in a first LBT procedure during the LBT occasion 515-d, which may be unsuccessful. After the unsuccessful first LBT procedure during the LBT occasion 515-d, the first UE may identify one or more additional LBT occasions 515 that temporally follow the LBT occasion 515-d, including an LBT occasion 515-e, an LBT occasion 515-f, and an LBT occasion 515-g. The first UE may participate in an unsuccessful LBT procedure during each of the LBT occasion 515-e and the LBT occasion 515-f and a successful LBT procedure during the LBT occasion 515-g. Based on performing the successful LBT procedure during the LBT occasion 515-g, the first UE may transmit the S-SSB 505-l to the second UE. As such, the quantity of S-SSB repetitions (e.g., repeated S-SSBs 505) transmitted by the first UE (e.g., one S-SSB 505-l) may be less than a quantity of S-SSB repetitions indicated by a network entity based on participating in the unsuccessful LBT procedure during the LBT occasion 515-d, the LBT occasion 515-e, and the LBT occasion 515-f.

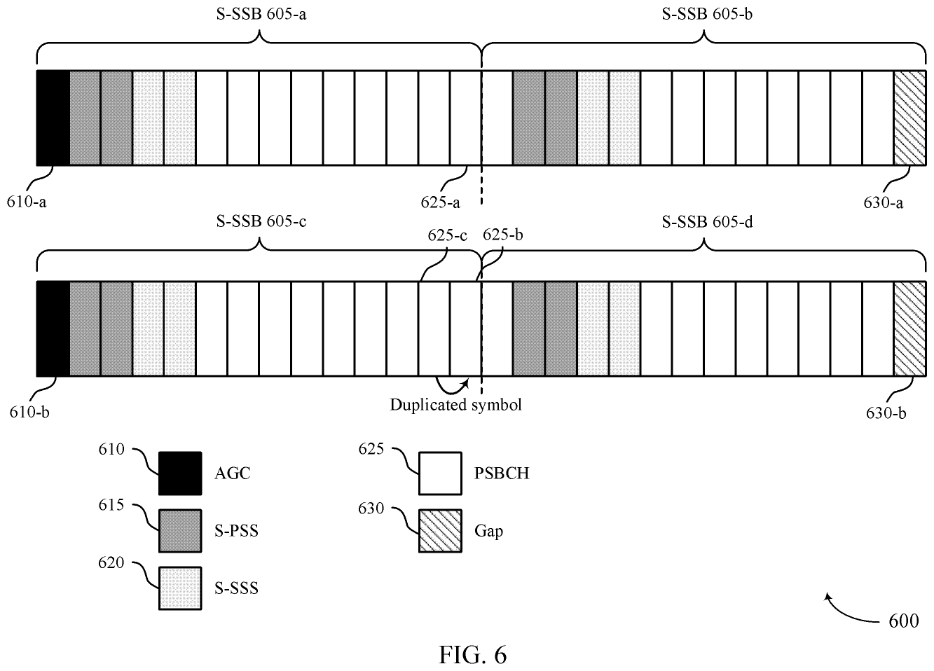

FIG. 6 illustrates an example of an S-SSB repetition scheme 600 that supports S-SSB transmission in an unlicensed band in accordance with one or more aspects of the present disclosure. In some examples, the S-SSB repetition scheme 600 may implement aspects of the wireless communications systems 100 and 200 or may be implemented by aspects of the wireless communications systems 100 and 200. For example, a first UE (e.g., a transmit UE) may transmit an S-SSB 605 to a second UE (e.g., a receive UE), where multiple S-SSBs 605 may be repeated in the time domain.

In some examples, the first UE may transmit more than one S-SSB 605 continuously. For example, the first UE may continuously transmit an S-SSB 605-a and an S-SSB 605-b, or the first UE may continuously transmit an S-SSB 605-c and an S-SSB 605-d. Each S-SSB 605 may each include at least one of an S-PSS symbol 615, an S-SSS symbol 620, a PSBCH symbol 625, and a gap symbol 630. In some examples, one AGC symbol 610 may be included in a continuous transmission of S-SSBs 605. For example, if the S-SSB 605-a and the S-SSB 605-b are transmitted continuously, the AGC symbol 610-a may be the only AGC symbol 610 in both S-SSBs 605. In some examples, when multiple S-SSBs 605 are transmitted continuously, any internal AGC symbols (e.g., the AGC symbol 610-a), gap symbols 630, or both included between the continuously transmitted S-SSBs 605 may be used for a PSBCH transmission (e.g., may effectively be PSBCH symbols 625).

In the case that the first UE transmits the S-SSB 605-a and the S-SSB 605-b continuously, the first symbol of the S-SSB 605-a may be the AGC symbol 610-a, which in some cases may be used for PSBCH transmissions. Additionally, or alternatively, the last symbol of the S-SSB 605-a may be a gap symbol 630, and as such, may be used for a PSBCH transmission as a PSBCH symbol 625-a. For example, the resource elements in the gap symbol 630 may be considered in a rate matching procedure to achieve a lower coding rate. As such, the first UE may select a specific set of bits associated with the resource elements for transmission of a PSBCH. The last symbol of the S-SSB 605-b may include a gap symbol 630-a, which may be the end of the continuous transmission of the S-SSB 605-a and the S-SSB 605-b.

In the case that the first UE transmits the S-SSB 605-c and the S-SSB 605-d continuously, an AGC symbol 610-b may be the only AGC symbol 610 for both S-SSBs 605. That is, the first symbol of the S-SSB 605-c may be the AGC symbol 610-b, which in some cases may be used for PSBCH transmissions. Additionally, or alternatively, the last symbol of the S-SSB 605-c may be a gap symbol 630, and as such, may be used for a PSBCH transmission as a PSBCH symbol 625-b. For example, the first UE may duplicate the PSBCH symbol 625-c (e.g., the previous symbol) onto the last symbol of the S-SSB 605-c such that the PSBCH symbol 625-b is a duplicate of the PSBCH symbol 625-c. The last symbol of the S-SSB 605-d may include a gap symbol 630-b, which may be the end of the continuous transmission of the S-SSB 605-c and the S-SSB 605-d.

In some cases, when transmitting the repetitions of the S-SSBs 605, timing information associated with the S-SSBs 605 may be in increasing order and independent of a PSBCH payload. In some examples, an N quantity of least-significant bits (LSBs) of a slot index may be used for DMRS scrambling. For example, if there are four repetitions of the S-SSBs 605 and the first UE transmits the S-SSBs 605 back-to-back, then two LSBs of the slot index may be used for DMRS scrambling. In this case, five most-significant bits (MSBs) of the slot index may be the same for each of the four S-SSBs, different timing information may be carried in the DMRS. As such, the S-SSB combination may be performed directly. Put another way, the MSBs may be carried in a PSBCH payload, and the LSBs may be carried in the DMRS.

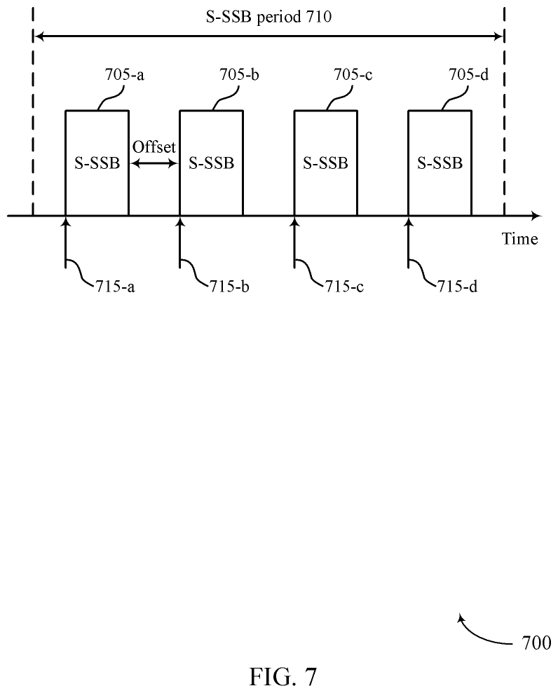

FIG. 7 illustrates an example of an S-SSB repetition scheme 700 that supports S-SSB transmission in an unlicensed band in accordance with one or more aspects of the present disclosure. In some examples, the S-SSB repetition scheme 700 may implement aspects of the wireless communications systems 100 and 200 or may be implemented by aspects of the wireless communications systems 100 and 200. For example, a first UE (e.g., a transmit UE) may transmit repetitions of S-SSBs 705 to a second UE (e.g., a receive UE) according to the S-SSB repetition scheme 700.

As described herein, the first UE and the second UE may perform sidelink communications in an unlicensed band. In some examples, the first UE may receive a message from a network entity indicating that the first UE is to transmit multiple S-SSBs 705 (e.g., S-SSB repetitions) within an S-SSB period 710. In some cases, the message may indicate that the first UE is to transmit the repetitions of the S-SSBs 705 in the time domain (e.g., in multiple slots). For example, the message may indicate that the first UE is to transmit an S-SSB 705-a, an S-SSB 705-b, an S-SSB 705-c, and an S-SSB 705-d within the S-SSB period 710. The first UE may transmit the S-SSBs 705 non-back-to-back (e.g., with an offset between consecutive S-SSBs 705). That is, the first UE may transmit the S-SSB 705-a, and after an offset, the first UE may transmit the S-SSB 705-b, and so on.

In some cases, the first UE may determine one or more LBT occasions 715 in association with the S-SSBs 705, where a timing of the LBT occasions 715 may be based on the first UE transmitting the S-SSBs 705 non-back-to-back. The first UE may identify multiple LBT occasions 715, each associated with one of the multiple S-SSBs 705 to be transmitted by the first UE. For example, the first UE may identify an LBT occasion 715-a associated with the S-SSB 705-a, an LBT occasion 715-b associated with the S-SSB 705-b, an LBT occasion 715-c associated with the S-SSB 705-c, and an LBT occasion 715-d associated with the S-SSB 705-d. The first UE may participate in an LBT procedure during the LBT occasion 715-a (e.g., a first LBT occasion). If the first LBT procedure is unsuccessful, the first UE may have a higher probability of performing a successful LBT procedure during the LBT occasion 715-b as the LBT occasion 715-b may experience less interference than the LBT occasion 715-a (e.g., a time interval between two LBT occasions 715 is much larger than a time interval between back-to-back S-SSB transmissions). That is, the LBT occasion 715-a may experience greater interference since it occurs before any S-SSB transmissions.

In some examples, the first UE may participate in an LBT procedure between other LBT occasions 715. For example, if the LBT procedure is unsuccessful during the LBT occasion 715-a, the first UE may participate in the LBT procedure during the LBT occasion 715-b or the LBT occasion 715-c and the LBT occasion 715-d. The first UE may transmit the S-SSBs 705 based on the first UE participating in the LBT procedure during multiple LBT occasions 715. For example, if the LBT procedure is successful during the LBT occasion 715-b, the first UE may transmit the S-SSB 705-b, the S-SSB 705-c, and the S-SSB 705-d.

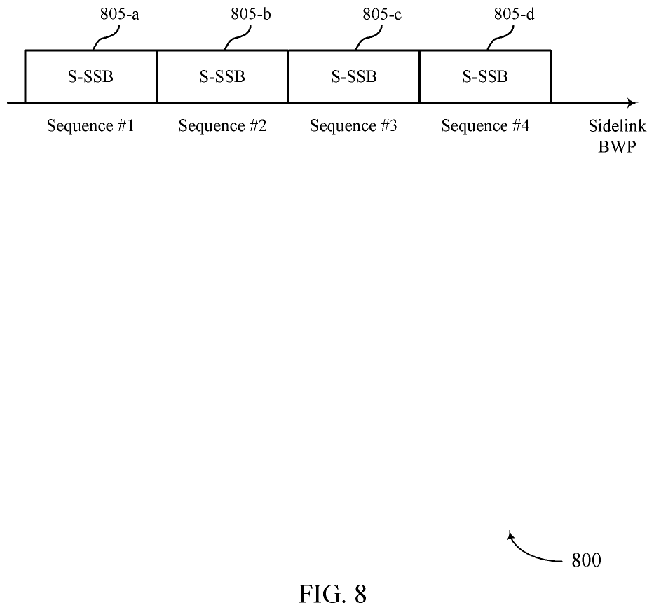

FIG. 8 illustrates an example of an S-SSB repetition scheme 800 that supports S-SSB transmission in an unlicensed band in accordance with one or more aspects of the present disclosure. In some examples, the S-SSB repetition scheme 800 may implement aspects of the wireless communications systems 100 and 200 or may be implemented by aspects of the wireless communications systems 100 and 200. For example, a first UE (e.g., a transmit UE) may transmit repetitions of S-SSBs 805 to a second UE (e.g., a receive UE) in the frequency domain according to the S-SSB repetition scheme 800.

As described herein, the first UE may identify a reference frequency position of a reference S-SSB in a sidelink BWP. The reference S-SSB may be an S-SSB 805-a (e.g., located at one side of the sidelink BWP). In some cases, the reference frequency position may be pre-configured, or the first UE may receive a message from a network entity indicating the reference frequency position. The first UE may transmit the S-SSB 805-a to the second UE in accordance with the reference frequency position. In addition, the first UE may transmit one or more additional S-SSBs 805 to the second UE, where the frequency positions of the one or more additional S-SSBs 805 may be different from but based on the reference frequency position. For example, the first UE may transmit an S-SSB 805-b, an S-SSB 805-c, and an S-SSB 805-d after the S-SSB 805-a (e.g., the S-SSB repetitions begin after the S-SSB 805-a). In addition, the S-SSB 805-b, the S-SSB 805-c, and the S-SSB 805-d (e.g., and any other S-SSBs 805 after the S-SSB 805-a) may be continuous in frequency.

In some examples, a quantity of S-SSBs 805 to be transmitted in one resource block set (e.g., in the sidelink BWP) may be hardcoded in association with an SCS. For example, the first UE may receive signaling from a network entity indicating an SCS configuration, the SCS configuration indicative of a quantity of S-SSBs 805 to be transmitted in the sidelink BWP by the first UE. The quantity of S-SSBs 805 may include the reference S-SSB (e.g., the S-SSB 805-a) and the one or more additional S-SSBs 805 (e.g., the S-SSB 805-b, the S-SSB 805-c, and the S-SSB 805-d). For example, the network entity may indicate a quantity of eight S-SSBs 805 for a 15 kHz SCS and four S-SSBs 805 for a 30 kHz SCS. In some examples, the network entity may transmit the indication of the SCS configuration in RRC signaling. In some cases, the quantity of S-SSBs 805 to be transmitted in the sidelink BWP by the first UE may be indicated directly via signaling (e.g., RRC signaling). That is, the network entity may transmit the signaling to the first UE indicating the quantity of S-SSBs 805. In some other cases, the quantity of S-SSBs 805 to be transmitted in the sidelink BWP by the first UE may be pre-configured.

To reduce a peak-to-average-power ratio (PAPR) associated with transmitting the multiple S-SSBs 805, the first UE may add a pseudo-noise sequence-based scrambling to each S-SSB 805 to encode each S-SSB 805. In some examples, a long scrambling sequence may be generated that spans across a quantity of N S-SSBs 805, where the long scrambling sequence may be divided into N pieces and applied to each S-SSB 805 individually. For example, the S-SSB 805-a may be associated with a first sequence (e.g., sequence #1), the S-SSB 805-b may be associated with a second sequence (e.g., sequence 2), the S-SSB 805-c may be associated with a third sequence (e.g., sequence #3), and the S-SSB 805-d may be associated with a fourth sequence (e.g., sequence #4). If the second UE is aware of at least one of the sequences applied to an S-SSB 805, the second UE may determine the other three sequences. That is, the second UE may decode the S-SSB 805-b, the S-SSB 805-c, and the S-SSB 805-d to identify the pseudo-noise sequence-based scrambling added to each S-SSB 805, where the pseudo-noise sequence-based scrambling may be different for each S-SSB 805.

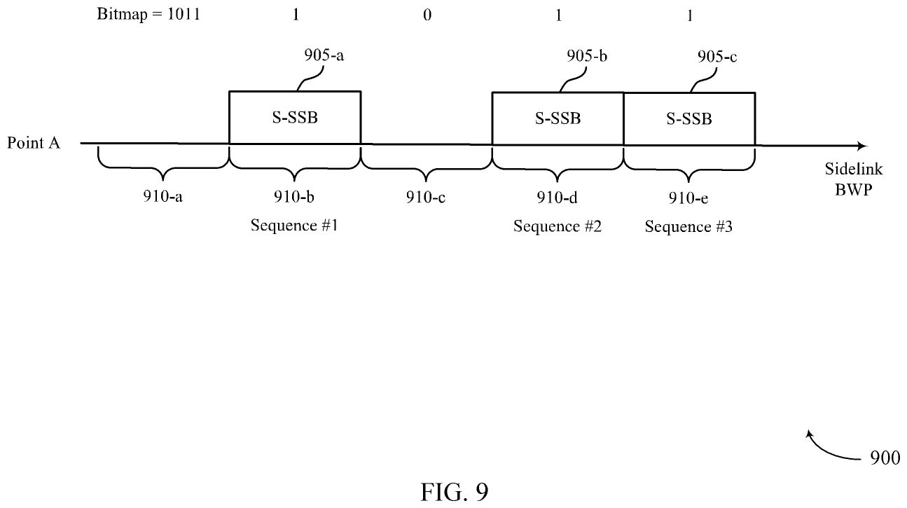

FIG. 9 illustrates an example of an S-SSB repetition scheme 900 that supports S-SSB transmission in an unlicensed band in accordance with one or more aspects of the present disclosure. In some examples, the S-SSB repetition scheme 900 may implement aspects of the wireless communications systems 100 and 200 or may be implemented by aspects of the wireless communications systems 100 and 200. For example, a first UE (e.g., a transmit UE) may transmit multiple repetitions of an S-SSB 905 to a second UE (e.g., a receive UE) in the frequency domain (e.g., in multiple resource block sets) in accordance with the S-SSB repetition scheme 900.

In some examples, the first UE may identify a reference frequency position of a reference S-SSB in a sidelink BWP. The reference S-SSB may be the S-SSB 905-a, and may be located in a particular resource block set 910 in a sidelink BWP. For example, the sidelink BWP may include a resource block set 910-a (e.g., resource block set #1), a resource block set 910-b (e.g., resource block set #2), a resource block set 910-c (e.g., resource block set #3), a resource block set 910-d (e.g., resource block set #4), and a resource block set 910-e (e.g., resource block set #5). As such, the S-SSB 905-a may be located in the resource block set 910-b (e.g., a second resource block set 910) in the sidelink BWP, and the resource block set 910-a (e.g., a first resource block set 910) may be empty. In addition, the S-SSB 905-a may be located closest to a point A, where the point A may serve as a common reference point for resource block grids, and where a center of a subcarrier 0 of a common resource block 0 for the SCS configuration μ may coincide with the point A.

In some cases, the reference frequency position may be pre-configured, or the first UE may receive a message from a network entity indicating the reference frequency position. The first UE may transmit the S-SSB 905-a to the second UE in accordance with the reference frequency position (e.g., using the resource block set 910-b). In addition, the first UE may transmit one or more additional S-SSBs 905 to the second UE, where the frequency positions of the one or more additional S-SSBs 905 may be different from but based on the reference frequency position. For example, the first UE may transmit an S-SSB 905-b in the resource block set 910-d and an S-SSB 905-c in the resource block set 910-e, such that the repetitions of the S-SSBs 905 may be transmitted after the S-SSB 905-a and the resource block set 910-c may be empty. In addition, the S-SSB 905-b and the S-SSB 905-c may be continuous or discontinuous in frequency (e.g., at least partially discontinuous in frequency).

In some examples, a quantity of S-SSBs 905 to be transmitted in the multiple resource block sets 910 in the sidelink BWP may be hardcoded in association with a mode of the first UE (e.g., a device mode). The quantity of S-SSBs 905 may include the reference S-SSB (e.g., the S-SSB 905-a) and the one or more additional S-SSBs 905 (e.g., the S-SSB 905-b and the S-SSB 805-c). For example, sixteen S-SSBs 905 may be configured for an LPI and eight S-SSBs 905 may be configured for a VLP mode. In some other examples, the quantity of S-SSBs 905 to be transmitted in the sidelink BWP by the first UE may be pre-configured.

In some cases, the network entity may transmit an indication of the quantity of S-SSBs 905 to be transmitted in the sidelink BWP by the first UE via signaling (e.g., RRC signaling). The signaling may include a bitmap used to indicate the quantity of S-SSBs 905. In some examples, each bit in the bitmap may correspond to one resource block set 910. As such, a “1” bit may indicate that an S-SSB 905 is to be transmitted in a corresponding resource block set 910, and a “0” but may indicate that a corresponding resource block set 910 is empty (e.g., no S-SSB 905 may be transmitted in that resource blocks set 910). In addition, to reduce signaling overhead, a first bit of the bitmap may correspond to the resource block set 910 that includes the S-SSB 905-a (e.g., the reference S-SSB). For example, the signaling may include a bitmap 1011, and the corresponding bits (e.g., 1, 0, 1, 1) may correspond to the resource block set 910-b, the resource block set 910-c, the resource block set 910-d, and the resource block set 910-e, respectively, such that the first bit corresponds to the second resource block set 910 (e.g., the resource block set 910-b) and the first resource block set 910 (e.g., the resource block set 910-a) may lack association with a bit in the bitmap.

To reduce a PAPR associated with transmitting the multiple S-SSBs 905, the first UE may add a pseudo-noise sequence-based scrambling to each S-SSB 905 to encode each S-SSB 905. In some examples, a long scrambling sequence may be generated that spans across a quantity of N S-SSBs 905, where the long scrambling sequence may be divided into N pieces and applied to each S-SSB 905 individually. For example, the S-SSB 905-a may be associated with a first sequence (e.g., sequence #1), the S-SSB 905-b may be associated with a second sequence (e.g., sequence 2), and the S-SSB 905-c may be associated with a third sequence (e.g., sequence #3). If the second UE is aware of at least one of the sequences applied to an S-SSB 905, the second UE may determine the other three sequences. That is, the second UE may decode the S-SSB 905-b and the S-SSB 905-c to identify the pseudo-noise sequence-based scrambling added to each S-SSB 905, where the pseudo-noise sequence-based scrambling may be different for each S-SSB 905.

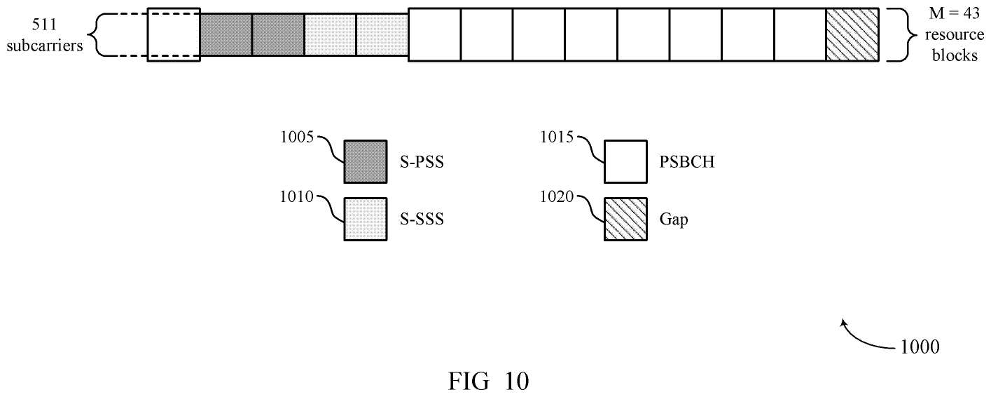

FIG. 10 illustrates an example of an S-SSB 1000 that supports S-SSB transmission in an unlicensed band in accordance with one or more aspects of the present disclosure. In some examples, the S-SSB 1000 may implement aspects of the wireless communications systems 100 and 200 or may be implemented by aspects of the wireless communications systems 100 and 200. In some examples, the S-SSB 1000 may include at least one of an S-PSS symbol 1005, an S-SSS symbol 1010, a PSBCH symbol 1015, and a gap symbol 1020.

In some examples, a first UE (e.g., a transmit UE) may extend a bandwidth of an S-PSS symbol 1005, an S-SSS symbol 1010, a PSBCH symbol 1015, or any combination thereof (e.g., in the frequency domain) to support a wideband S-SSB. For example, the first UE may extend the bandwidth of an S-PSS symbol 1005 and an S-SSS symbol 1010 from 127 resource blocks to X resource blocks, where X=2ⁿ−1, 7≤n≤9 (e.g., in some examples, X=511). Based on increasing the bandwidths used for transmitting P-SSSs and S-SSSs, an associated transmit power may also be increased. In the frequency domain, the S-SSB 1000 may span a quantity of M=[X/12] resource blocks within a sidelink BWP (e.g., M=43 resource blocks). In addition, the first UE may extend the bandwidth of a PSBCH symbol 1015 to [X/12] resource blocks. In some cases, a wideband PSBCH in this way may be implemented via a lower coding rate or a larger payload size. In some examples, the wideband S-SSB may be implemented in cases where the first UE transmits multiple S-SSB repetitions in the time domain or the frequency domain, or the wideband S-SSB may be implemented for single S-SSB transmissions.

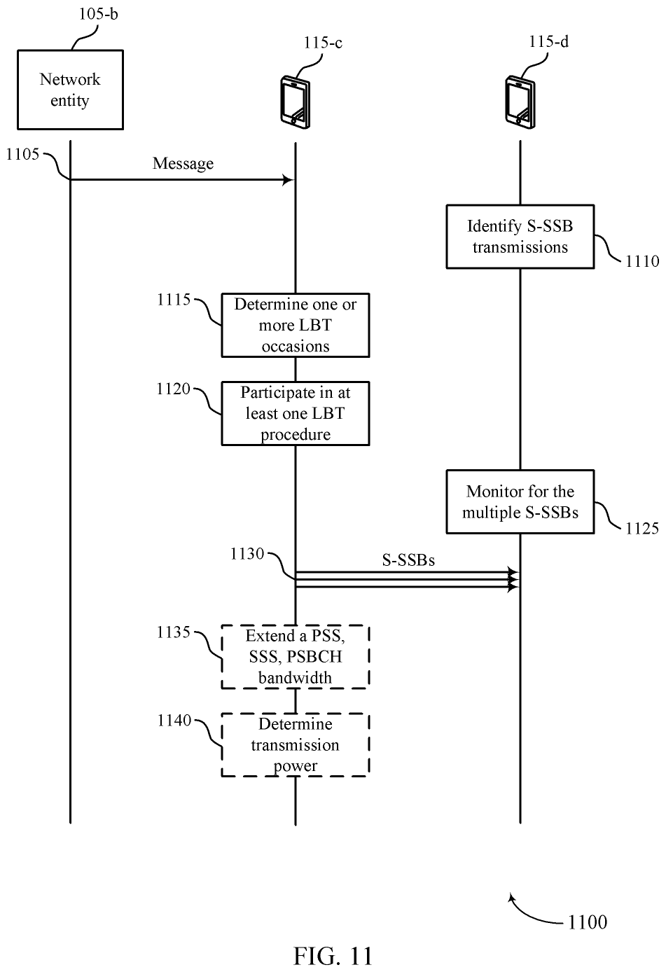

FIG. 11 illustrates an example of a process flow 1100 that supports S-SSB transmission in an unlicensed band in accordance with one or more aspects of the present disclosure. The process flow 1100 may implement aspects of wireless communications systems 100 and 200, or may be implemented by aspects of the wireless communications system 100 and 200. For example, the process flow 1100 may illustrate operations between a UE 115-c, a UE 115-d, and a network entity 105-b, which may be examples of corresponding devices described herein. In the following description of the process flow 1100, the operations between the UE 115-c, the UE 115-d, and the network entity 105-b may be transmitted in a different order than the example order shown, or the operations performed by the UE 115-c, the UE 115-d, and the network entity 105-b may be performed in different orders or at different times. Some operations may also be omitted from the process flow 1100, and other operations may be added to the process flow 1100.

At 1105, the UE 115-c (e.g., a transmit UE) may receive, from the network entity 105-b, a message indicating that the UE 115-c is to transmit multiple S-SSBs within an S-SSB period, the message also indicative of whether the multiple S-SSBs are to be transmitted back-to-back or with an offset between consecutive ones of the multiple S-SSBs (e.g., non-back-to-back). In some examples, the message may indicate that the UE 115-c is to transmit the multiple S-SSBs in an S-SSB instance within the S-SSB period. At 1110, the UE 115-d (e.g., a receive UE) may identify (e.g., via a message) that the UE 115-c is to transmit the multiple S-SSBs within the S-SSB period.

At 1115, the UE 115-c may determine one or more LBT occasions in association with the multiple S-SSBs, where a timing of the one or more LBT occasions is based on whether the multiple S-SSBs are to be transmitted back-to-back or with the offset between the consecutive ones of the multiple S-SSBs. For example, the UE 115-c may identify a first LBT occasion associated with a temporally first of the multiple S-SSBs. In addition, the UE 115-c may identify multiple other LBT occasions after the first LBT occasion, during which the UE 115-c may participate in LBT procedures if a first LBT procedure during the first LBT occasion is unsuccessful.

At 1120, the UE 115-c may participate in at least one LBT procedure during the one or more LBT occasions. For example, the UE 115-c may participate in an LBT procedure during the first LBT occasion, which may be successful or unsuccessful. In the case that the first LBT procedure is unsuccessful, the UE 115-c may participate in the LBT procedure during one or more additional LBT occasions until it is successful.

At 1125, the UE 115-d may monitor for the multiple S-SSBs transmitted by the UE 115-c. At 1130, the UE 115-c may transmit the multiple S-SSBs to the UE 115-d. In some examples, the UE 115-c may transmit the multiple S-SSBs back-to-back or with the offset between consecutive S-SSBs within an S-SSB period. In addition, the UE 115-c may transmit the multiple S-SSBs continuously, in which case internal AGC or gap symbols may be used for PSBCH transmissions.

At 1135, the UE 115-c may extend a first bandwidth of a P-SSS of an S-SSB, a second bandwidth of an S-SSS of an S-SSB, or a third bandwidth of a PSBCH of an S-SSB within a sidelink BWP. For example, the third bandwidth of the PSBCH may be extended based on lowering a coding rate, increasing a payload size, or both. The UE 115-c may extend the bandwidths of the P-SSS, the S-SSS, the PSBCH, or any combination thereof in cases where the UE 115-c transmits multiple repetitions of the S-SSB in the time domain, or in cases where the UE 115-c transmits a single S-SSB.

At 1140, the UE 115-c may determine a power for transmitting the multiple S-SSBs or a PSBCH based on a quantity of resource blocks for transmitting the multiple S-SSBs or the PSBCH for an identified SCS configuration. That is, the power may be based on a particular quantity of resource blocks rather than a fixed quantity representing a bandwidth of an S-SSB.

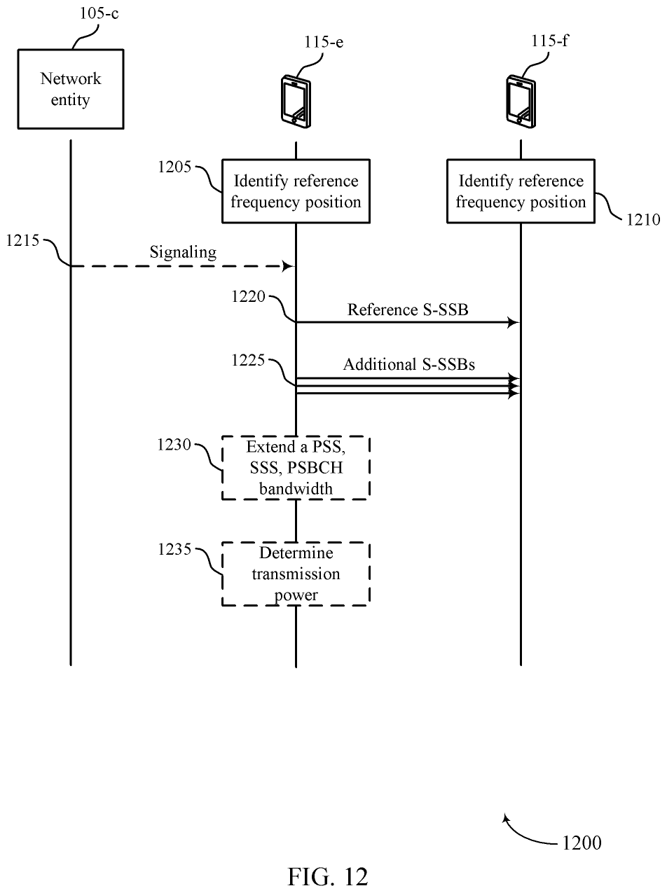

FIG. 12 illustrates an example of a process flow 1200 that supports S-SSB transmission in an unlicensed band in accordance with one or more aspects of the present disclosure. The process flow 1200 may implement aspects of wireless communications systems 100 and 200, or may be implemented by aspects of the wireless communications system 100 and 200. For example, the process flow 1200 may illustrate operations between a UE 115-e, a UE 115-f, and a network entity 105-c, which may be examples of corresponding devices described herein. In the following description of the process flow 1200, the operations between the UE 115-e, the UE 115-f, and the network entity 105-c may be transmitted in a different order than the example order shown, or the operations performed by the UE 115-e, the UE 115-f, and the network entity 105-c may be performed in different orders or at different times. Some operations may also be omitted from the process flow 1200, and other operations may be added to the process flow 1200.

At 1205, the UE 115-e (e.g., a transmit UE) may identify a reference position of a reference S-SSB in a sidelink BWP. For example, the reference position may be at the start of the sidelink BWP. In some examples, the reference position may be indicated in a message transmitted the network entity 105-c. At 1210, the UE 115-f (e.g., a receive UE) may identify a reference position of a reference S-SSB in a sidelink BWP. For example, the reference position may be at the start of the sidelink BWP. In some examples, the reference position may be indicated in a message transmitted by the network entity 105-c.

At 1215, the UE 115-e may receive signaling from the network entity 105-c indicating an SCS configuration indicative of a quantity of S-SSBs to be transmitted in the sidelink BWP by the UE 115-e, where the quantity of S-SSBs may include the reference S-SSB and one or more additional S-SSBs, and where the UE 115-e may identify the quantity of S-SSBs to transmit based on receiving the signaling. Additionally, or alternatively, the signaling may directly indicate the quantity of S-SSBs to be transmitted in the sidelink BWP by the UE 115-e (e.g., via RRC signaling).

At 1220, the UE 115-e may transmit, to the UE 115-f, the reference S-SSB in accordance with the reference frequency position. For example, the UE 115-e may transmit the reference S-SSB at the beginning of the sidelink BWP.

At 1225, the UE 115-e may transmit, to the UE 115-f, the one or more additional S-SSBs whose frequency positions are different from but based on the reference frequency position. For example, the frequency positions of the one or more additional S-SSBs may be after the reference S-SSB in the frequency domain. In addition, the one or more additional S-SSBs may be continuous or at least partially discontinuous in frequency, and may be transmitted per resource block or per resource block set.

At 1230, the UE 115-e may extend a first bandwidth of a P-SSS of an S-SSB, a second bandwidth of an S-SSS of an S-SSB, or a third bandwidth of a PSBCH of an S-SSB within a sidelink BWP. For example, the third bandwidth of the PSBCH may be extended based on lowering a coding rate, increasing a payload size, or both. The UE 115-e may extend the bandwidths of the P-SSS, the S-SSS, the PSBCH, or any combination thereof in cases where the UE 115-e transmits the one or more additional S-SSBs, or in cases where the UE 115-e transmits a single S-SSB.

At 1235, the UE 115-e may determine a power for transmitting the one or more additional S-SSBs or a PSBCH based on a quantity of resource blocks for transmitting the one or more additional S-SSBs or the PSBCH for an identified SCS configuration. That is, the power may be based on a particular quantity of resource blocks rather than a fixed quantity representing a bandwidth of an S-SSB.

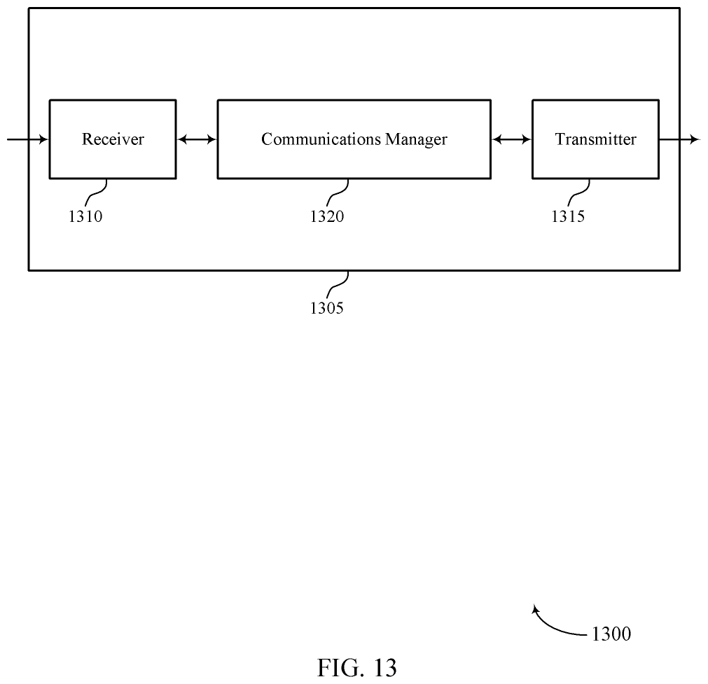

FIG. 13 shows a block diagram 1300 of a device 1305 that supports S-SSB transmission in an unlicensed band in accordance with one or more aspects of the present disclosure. The device 1305 may be an example of aspects of a UE 115 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for receiving information such as packets, user data, control information, or any combination thereof associated with various information channels (e.g., control channels, data channels, information channels related to S-SSB transmission in an unlicensed band). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to S-SSB transmission in an unlicensed band). In some examples, the transmitter 1315 may be co-located with a receiver 1310 in a transceiver module. The transmitter 1315 may utilize a single antenna or a set of multiple antennas.

The communications manager 1320, the receiver 1310, the transmitter 1315, or various combinations thereof or various components thereof may be examples of means for performing various aspects of S-SSB transmission in an unlicensed band as described herein. For example, the communications manager 1320, the receiver 1310, the transmitter 1315, or various combinations or components thereof may support a method for performing one or more of the functions described herein.

In some examples, the communications manager 1320, the receiver 1310, the transmitter 1315, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1320, the receiver 1310, the transmitter 1315, or various combinations or components thereof may be implemented in code (e.g., as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication at a first UE in accordance with examples as disclosed herein. For example, the communications manager 1320 may be configured as or otherwise support a means for receiving, from a network entity, a message indicating that the first UE is to transmit multiple S-SSBs within an S-SSB period, the message also indicative of whether the multiple S-SSBs are to be transmitted back-to-back or with an offset between consecutive ones of the multiple S-SSBs. The communications manager 1320 may be configured as or otherwise support a means for determining one or more LBT occasions in association with the multiple S-SSBs, where a timing of the one or more LBT occasions is based on whether the multiple S-SSBs are to be transmitted back-to-back or with the offset between the consecutive ones of the multiple S-SSBs. The communications manager 1320 may be configured as or otherwise support a means for participating in at least one LBT procedure during the one or more LBT occasions. The communications manager 1320 may be configured as or otherwise support a means for transmitting, to a second UE, the multiple S-SSBs.

Additionally, or alternatively, the communications manager 1320 may support wireless communication at a first UE in accordance with examples as disclosed herein. For example, the communications manager 1320 may be configured as or otherwise support a means for identifying, via a message, that a second UE is to transmit multiple S-SSBs within an S-SSB period, the message also indicative of whether the multiple S-SSBs are to be transmitted back-to-back or with an offset between consecutive ones of the multiple S-SSBs. The communications manager 1320 may be configured as or otherwise support a means for monitoring for the multiple S-SSBs transmitted by the second UE in accordance with the message. The communications manager 1320 may be configured as or otherwise support a means for receiving, from the second UE, at least one of the multiple S-SSBs.

Additionally, or alternatively, the communications manager 1320 may support wireless communication at a first UE in accordance with examples as disclosed herein. For example, the communications manager 1320 may be configured as or otherwise support a means for identifying a reference frequency position of a reference S-SSB in a sidelink BWP. The communications manager 1320 may be configured as or otherwise support a means for transmitting, to a second UE, the reference S-SSB in accordance with the reference frequency position. The communications manager 1320 may be configured as or otherwise support a means for transmitting, to the second UE, one or more additional S-SSBs whose frequency positions are different from but based on the reference frequency position.

Additionally, or alternatively, the communications manager 1320 may support wireless communication at a first UE in accordance with examples as disclosed herein. For example, the communications manager 1320 may be configured as or otherwise support a means for identifying a reference frequency position of a reference S-SSB in a sidelink BWP. The communications manager 1320 may be configured as or otherwise support a means for receiving, from a second UE, the reference S-SSB in accordance with the reference frequency position. The communications manager 1320 may be configured as or otherwise support a means for receiving, from the second UE, one or more additional S-SSBs whose frequency positions are different from but based on the reference frequency position.

By including or configuring the communications manager 1320 in accordance with examples as described herein, the device 1305 (e.g., a processor controlling or otherwise coupled with the receiver 1310, the transmitter 1315, the communications manager 1320, or a combination thereof) may support techniques for transmitting S-SSB repetitions in an unlicensed band, which may increase the signal strength of S-SSB transmissions, thereby increasing the success rates of the transmissions.

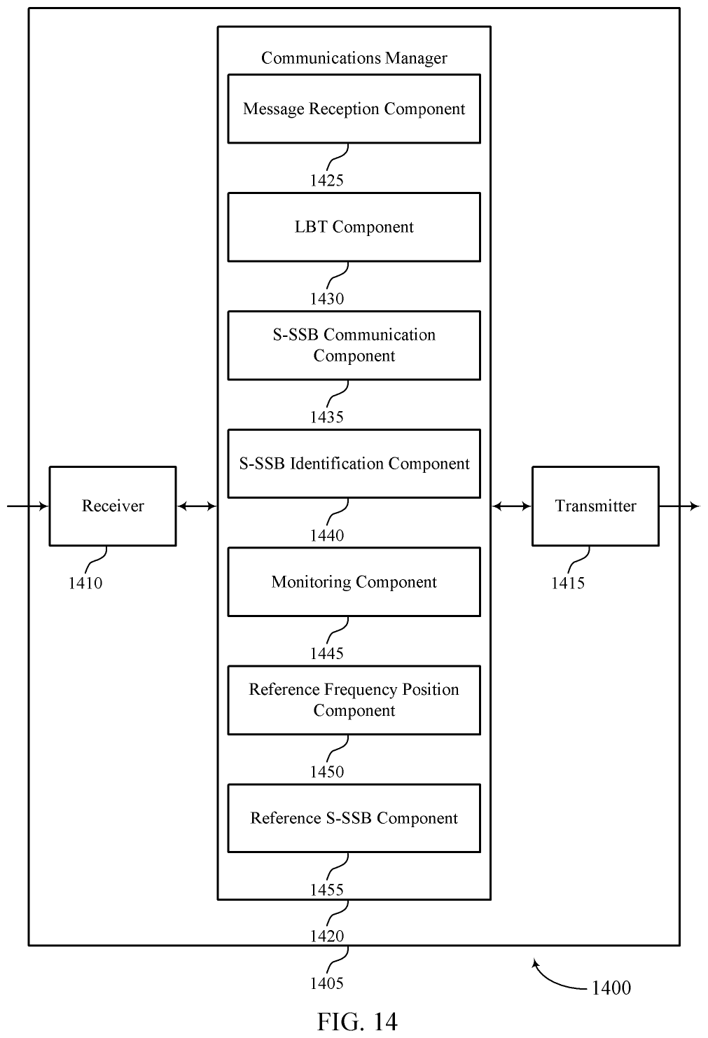

FIG. 14 shows a block diagram 1400 of a device 1405 that supports S-SSB transmission in an unlicensed band in accordance with one or more aspects of the present disclosure. The device 1405 may be an example of aspects of a device 1305 or a UE 115 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for receiving information such as packets, user data, control information, or any combination thereof associated with various information channels (e.g., control channels, data channels, information channels related to S-SSB transmission in an unlicensed band). Information may be passed on to other components of the device 1405. The receiver 1410 may utilize a single antenna or a set of multiple antennas.

The transmitter 1415 may provide a means for transmitting signals generated by other components of the device 1405. For example, the transmitter 1415 may transmit information such as packets, user data, control information, or any combination thereof associated with various information channels (e.g., control channels, data channels, information channels related to S-SSB transmission in an unlicensed band). In some examples, the transmitter 1415 may be co-located with a receiver 1410 in a transceiver module. The transmitter 1415 may utilize a single antenna or a set of multiple antennas.

The device 1405, or various components thereof, may be an example of means for performing various aspects of S-SSB transmission in an unlicensed band as described herein. For example, the communications manager 1420 may include a message reception component 1425, an LBT component 1430, an S-SSB communication component 1435, an S-SSB identification component 1440, a monitoring component 1445, a reference frequency position component 1450, a reference S-SSB component 1455, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communication at a first UE in accordance with examples as disclosed herein. The message reception component 1425 may be configured as or otherwise support a means for receiving, from a network entity, a message indicating that the first UE is to transmit multiple S-SSBs within an S-SSB period, the message also indicative of whether the multiple S-SSBs are to be transmitted back-to-back or with an offset between consecutive ones of the multiple S-SSBs. The LBT component 1430 may be configured as or otherwise support a means for determining one or more LBT occasions in association with the multiple S-SSBs, where a timing of the one or more LBT occasions is based on whether the multiple S-SSBs are to be transmitted back-to-back or with the offset between the consecutive ones of the multiple S-SSBs. The LBT component 1430 may be configured as or otherwise support a means for participating in at least one LBT procedure during the one or more LBT occasions. The S-SSB communication component 1435 may be configured as or otherwise support a means for transmitting, to a second UE, the multiple S-SSBs.

Additionally, or alternatively, the communications manager 1420 may support wireless communication at a first UE in accordance with examples as disclosed herein. The S-SSB identification component 1440 may be configured as or otherwise support a means for identifying, via a message, that a second UE is to transmit multiple S-SSBs within an S-SSB period, the message also indicative of whether the multiple S-SSBs are to be transmitted back-to-back or with an offset between consecutive ones of the multiple S-SSBs. The monitoring component 1445 may be configured as or otherwise support a means for monitoring for the multiple S-SSBs transmitted by the second UE in accordance with the message. The S-SSB communication component 1435 may be configured as or otherwise support a means for receiving, from the second UE, at least one of the multiple S-SSBs.

Additionally, or alternatively, the communications manager 1420 may support wireless communication at a first UE in accordance with examples as disclosed herein. The reference frequency position component 1450 may be configured as or otherwise support a means for identifying a reference frequency position of a reference S-SSB in a sidelink BWP. The reference S-SSB component 1455 may be configured as or otherwise support a means for transmitting, to a second UE, the reference S-SSB in accordance with the reference frequency position. The S-SSB communication component 1435 may be configured as or otherwise support a means for transmitting, to the second UE, one or more additional S-SSBs whose frequency positions are different from but based on the reference frequency position.

Additionally, or alternatively, the communications manager 1420 may support wireless communication at a first UE in accordance with examples as disclosed herein. The reference frequency position component 1450 may be configured as or otherwise support a means for identifying a reference frequency position of a reference S-SSB in a sidelink BWP. The reference S-SSB component 1455 may be configured as or otherwise support a means for receiving, from a second UE, the reference S-SSB in accordance with the reference frequency position. The S-SSB communication component 1435 may be configured as or otherwise support a means for receiving, from the second UE, one or more additional S-SSBs whose frequency positions are different from but based on the reference frequency position.

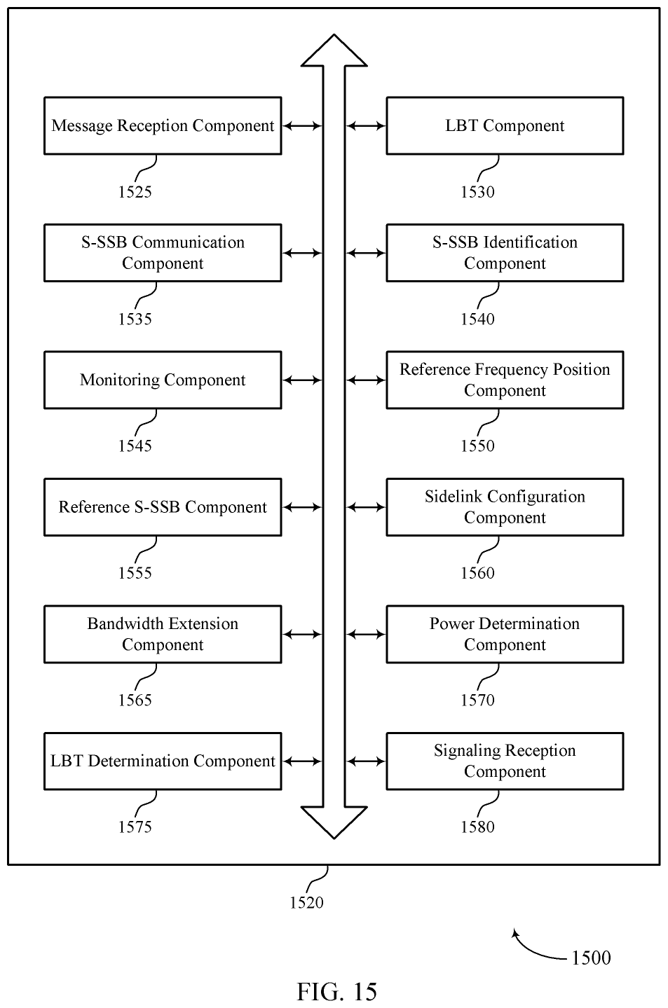

FIG. 15 shows a block diagram 1500 of a communications manager 1520 that supports S-SSB transmission in an unlicensed band in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of S-SSB transmission in an unlicensed band as described herein. For example, the communications manager 1520 may include a message reception component 1525, an LBT component 1530, an S-SSB communication component 1535, an S-SSB identification component 1540, a monitoring component 1545, a reference frequency position component 1550, a reference S-SSB component 1555, a sidelink configuration component 1560, a bandwidth extension component 1565, a power determination component 1570, an LBT determination component 1575, a signaling reception component 1580, or any combination thereof. Each of these components may communicate, directly or indirectly, with one another (e.g., via one or more buses).

The communications manager 1520 may support wireless communication at a first UE in accordance with examples as disclosed herein. The message reception component 1525 may be configured as or otherwise support a means for receiving, from a network entity, a message indicating that the first UE is to transmit multiple S-SSBs within an S-SSB period, the message also indicative of whether the multiple S-SSBs are to be transmitted back-to-back or with an offset between consecutive ones of the multiple S-SSBs. The LBT component 1530 may be configured as or otherwise support a means for determining one or more LBT occasions in association with the multiple S-SSBs, where a timing of the one or more LBT occasions is based on whether the multiple S-SSBs are to be transmitted back-to-back or with the offset between the consecutive ones of the multiple S-SSBs. In some examples, the LBT component 1530 may be configured as or otherwise support a means for participating in at least one LBT procedure during the one or more LBT occasions. The S-SSB communication component 1535 may be configured as or otherwise support a means for transmitting, to a second UE, the multiple S-SSBs.

In some examples, to support receiving the message indicating that the first UE is to transmit multiple S-SSBs within the S-SSB period, the sidelink configuration component 1560 may be configured as or otherwise support a means for receiving an indication of a sidelink configuration, the sidelink configuration indicating that the first UE is to transmit the multiple S-SSBs within an S-SSB instance of the S-SSB period.

In some examples, the sidelink configuration component 1560 may be configured as or otherwise support a means for determining, based at least on an RRC parameter of the sidelink configuration, a determined quantity of the multiple S-SSBs for inclusion within the S-SSB instance.

In some examples, the sidelink configuration defines an interval between starting times of consecutive S-SSB instances, where the interval allows for the multiple S-SSBs to be included within a first S-SSB instance without overlapping a second S-SSB instance of the consecutive S-SSB instances.

In some examples, the sidelink configuration indicating that the multiple S-SSBs are to transmitted within the S-SSB instance is indicative that the multiple S-SSBs are to be transmitted back-to-back.

In some examples, to support receiving the message indicating that the first UE is to transmit multiple S-SSBs within the S-SSB period, the sidelink configuration component 1560 may be configured as or otherwise support a means for receiving an indication of a sidelink configuration, the sidelink configuration indicating that the first UE is to transmit the multiple S-SSBs within a corresponding multiple S-SSB instances of the S-SSB period.

In some examples, to support transmitting the multiple S-SSBs, the S-SSB communication component 1535 may be configured as or otherwise support a means for transmitting the multiple S-SSBs back-to-back within the S-SSB period.

In some examples, to support determining the one or more LBT occasions, the LBT determination component 1575 may be configured as or otherwise support a means for identifying a first LBT occasion associated with a temporally first of the multiple S-SSBs, where the at least one LBT occasion during which the first UE participates in the listen-to-talk procedure is the first LBT occasion, the transmitting of the multiple S-SSBs based on the first UE participating in the LBT procedure during only the first LBT occasion.

In some examples, to support determining the one or more LBT occasions, the LBT determination component 1575 may be configured as or otherwise support a means for identifying a first LBT occasion associated with a temporally first of the multiple S-SSBs, where the first UE participates in an unsuccessful LBT procedure during the first LBT occasion. In some examples, to support determining the one or more LBT occasions, the LBT determination component 1575 may be configured as or otherwise support a means for identifying one or more additional LBT occasions that temporally follow the first LBT occasion, where the at least one LBT occasion during which the first UE participates in the listen-to-talk procedure includes one of the one or more additional LBT occasions after also participating in the unsuccessful LBT procedure.

In some examples, the S-SSB communication component 1535 may be configured as or otherwise support a means for determining, based on the message, a quantity of the multiple S-SSBs for transmission, where less than the quantity is transmitted based on the first UE participating in the unsuccessful LBT procedure during the first LBT occasion.

In some examples, the S-SSB communication component 1535 may be configured as or otherwise support a means for determining that one or more AGC or gap symbols are during a transmission interval for the multiple S-SSBs. In some examples, the S-SSB communication component 1535 may be configured as or otherwise support a means for transmitting a sidelink broadcast channel during the one or more AGC or gap symbols based on the multiple S-SSBs being transmitted back-to-back.

In some examples, to support transmitting the sidelink broadcast channel, the S-SSB communication component 1535 may be configured as or otherwise support a means for transmitting the sidelink broadcast channel during a gap symbol by including resource elements of the gap symbol in rate matching or by duplicating a previously transmitted sidelink broadcast channel.

In some examples, to support transmitting the multiple S-SSBs, the S-SSB communication component 1535 may be configured as or otherwise support a means for transmitting the multiple S-SSBs with the offset between consecutive ones of the multiple S-SSBs.

In some examples, to support determining the one or more LBT occasions, the LBT determination component 1575 may be configured as or otherwise support a means for identifying a set of multiple LBT occasions, each associated with one of the multiple S-SSBs, the transmitting of the multiple S-SSBs based on the first UE participating in the LBT procedure during multiple ones of the set of multiple LBT occasions.

In some examples, the bandwidth extension component 1565 may be configured as or otherwise support a means for extending a first bandwidth of a PSS of an S-SSB, a second bandwidth of an SSS of one or more of the multiple S-SSBs, and a third bandwidth of a sidelink broadcast channel of the S-SSB within a sidelink BWP based on lowering a coding rate, increasing a payload size, or both.

In some examples, the power determination component 1570 may be configured as or otherwise support a means for determining a power for transmitting the one or more S-SSBs or a sidelink broadcast channel based on a quantity of resource blocks for transmitting the one or more S-SSBs or the sidelink broadcast channel for an identified sub-carrier spacing configuration.

Additionally, or alternatively, the communications manager 1520 may support wireless communication at a first UE in accordance with examples as disclosed herein. The S-SSB identification component 1540 may be configured as or otherwise support a means for identifying, via a message, that a second UE is to transmit multiple S-SSBs within an S-SSB period, the message also indicative of whether the multiple S-SSBs are to be transmitted back-to-back or with an offset between consecutive ones of the multiple S-SSBs. The monitoring component 1545 may be configured as or otherwise support a means for monitoring for the multiple S-SSBs transmitted by the second UE in accordance with the message. In some examples, the S-SSB communication component 1535 may be configured as or otherwise support a means for receiving, from the second UE, at least one of the multiple S-SSBs.

In some examples, to support identifying that the second UE is to transmit multiple S-SSBs within the S-SSB period, the sidelink configuration component 1560 may be configured as or otherwise support a means for receiving an indication of a sidelink configuration, the sidelink configuration indicating that the second UE is to transmit the multiple S-SSBs within an S-SSB instance of the S-SSB period.

In some examples, the sidelink configuration defines an interval between starting times of consecutive S-SSB instances, where the interval allows for the multiple S-SSBs to be included within a first S-SSB instance without overlapping a second S-SSB instance of the consecutive S-SSB instances.

In some examples, the sidelink configuration indicating that the multiple S-SSBs are to transmitted within the S-SSB instance is indicative that the multiple S-SSBs are to be transmitted back-to-back.

In some examples, to support identifying that the second UE is to transmit multiple S-SSBs within the S-SSB period, the sidelink configuration component 1560 may be configured as or otherwise support a means for receiving an indication of a sidelink configuration, the sidelink configuration indicating that the second UE is to transmit the multiple S-SSBs within a corresponding multiple S-SSB instances of the S-SSB period.

In some examples, to support receiving at least one of the multiple S-SSBs, the S-SSB communication component 1535 may be configured as or otherwise support a means for receiving a set of multiple the multiple S-SSBs back-to-back within the S-SSB period.

In some examples, the S-SSB communication component 1535 may be configured as or otherwise support a means for receiving a sidelink broadcast channel during one or more AGC or gap symbols based on the multiple S-SSBs being received back-to-back.

In some examples, to support receiving at least one of the multiple S-SSBs, the S-SSB communication component 1535 may be configured as or otherwise support a means for receiving a set of multiple the multiple S-SSBs with the offset between consecutive ones of the multiple S-SSBs.

In some examples, to support receiving at least one of the multiple S-SSBs, the S-SSB communication component 1535 may be configured as or otherwise support a means for blind detecting for the multiple S-SSBs. In some examples, to support receiving at least one of the multiple S-SSBs, the S-SSB communication component 1535 may be configured as or otherwise support a means for determining that a received signal is one of the multiple S-SSBs based on a comparison of a correlation energy of the received signal with a threshold.

Additionally, or alternatively, the communications manager 1520 may support wireless communication at a first UE in accordance with examples as disclosed herein. The reference frequency position component 1550 may be configured as or otherwise support a means for identifying a reference frequency position of a reference S-SSB in a sidelink BWP. The reference S-SSB component 1555 may be configured as or otherwise support a means for transmitting, to a second UE, the reference S-SSB in accordance with the reference frequency position. In some examples, the S-SSB communication component 1535 may be configured as or otherwise support a means for transmitting, to the second UE, one or more additional S-SSBs whose frequency positions are different from but based on the reference frequency position.

In some examples, the message reception component 1525 may be configured as or otherwise support a means for receiving, from a network entity, a message indicating the reference frequency position of the reference S-SSB in the sidelink BWP.

In some examples, to support transmitting the one or more additional S-SSBs, the S-SSB communication component 1535 may be configured as or otherwise support a means for transmitting the one or more additional S-SSBs whose frequency positions are different from but based on the reference frequency position, where the one or more additional S-SSBs are continuous in frequency.

In some examples, the signaling reception component 1580 may be configured as or otherwise support a means for receiving, from a network entity, signaling indicating a sub-carrier spacing configuration, the sub-carrier spacing configuration indicative of a quantity of S-SSBs to be transmitted in the sidelink BWP by the first UE, the S-SSBs including the reference S-SSB and the one or more additional S-SSBs. In some examples, the signaling reception component 1580 may be configured as or otherwise support a means for identifying the quantity of S-SSBs to be transmitted in the sidelink BWP by the first UE based on receiving the signaling.

In some examples, the signaling reception component 1580 may be configured as or otherwise support a means for receiving, from a network entity, signaling indicating a quantity of S-SSBs to be transmitted in the sidelink BWP by the first UE, the S-SSBs including the reference S-SSB and the one or more additional S-SSBs.

In some examples, the S-SSB communication component 1535 may be configured as or otherwise support a means for identifying a quantity of S-SSBs to be transmitted in the sidelink BWP by the first UE, where the quantity of S-SSBs is pre-configured, and where the S-SSBs include the reference S-SSB and the one or more additional S-SSBs.

In some examples, to support transmitting the one or more additional S-SSBs, the S-SSB communication component 1535 may be configured as or otherwise support a means for transmitting the one or more additional S-SSBs whose frequency positions are different from but based on the reference frequency position, where the one or more additional S-SSBs are at least partially discontinuous in frequency.

In some examples, a quantity of S-SSBs is based on a mode of the first UE, where the mode includes a low power indoor mode or a very low power mode, and where the S-SSBs include the reference S-SSBs and the one or more additional S-SSBs.

In some examples, the S-SSB communication component 1535 may be configured as or otherwise support a means for receiving, from a network entity, signaling indicating a bitmap indicative of a quantity of S-SSBs to be transmitted in the sidelink BWP by the first UE, the S-SSBs including the reference S-SSB and the one or more additional S-SSBs, and where a first bit of the bitmap corresponds to the reference S-SSB.

In some examples, the bandwidth extension component 1565 may be configured as or otherwise support a means for extending a first bandwidth of a PSS of an S-SSB, a second bandwidth of an SSS of one or more multiple S-SSBs, and a third bandwidth of a sidelink broadcast channel of the S-SSB within a sidelink BWP based on lowering a coding rate, increasing a payload size, or both.

In some examples, the power determination component 1570 may be configured as or otherwise support a means for determining a power for transmitting an S-SSB or a sidelink broadcast channel based on a quantity of resource blocks for transmitting the S-SSB or the sidelink broadcast channel with a sub-carrier spacing configuration.

Additionally, or alternatively, the communications manager 1520 may support wireless communication at a first UE in accordance with examples as disclosed herein. In some examples, the reference frequency position component 1550 may be configured as or otherwise support a means for identifying a reference frequency position of a reference S-SSB in a sidelink BWP. In some examples, the reference S-SSB component 1555 may be configured as or otherwise support a means for receiving, from a second UE, the reference S-SSB in accordance with the reference frequency position. In some examples, the S-SSB communication component 1535 may be configured as or otherwise support a means for receiving, from the second UE, one or more additional S-SSBs whose frequency positions are different from but based on the reference frequency position.

In some examples, the message reception component 1525 may be configured as or otherwise support a means for receiving, from a network entity, a message indicating the reference frequency position of the reference S-SSB in the sidelink BWP.

In some examples, to support receiving the one or more additional S-SSBs, the S-SSB communication component 1535 may be configured as or otherwise support a means for receiving the one or more additional S-SSBs whose frequency positions are different from but based on the reference frequency position, where the one or more additional S-SSBs are continuous in frequency.

In some examples, the S-SSB communication component 1535 may be configured as or otherwise support a means for decoding the one or more additional S-SSBs to identify pseudo-noise sequence-based scrambling added to each S-SSB of the one or more additional S-SSBs, where a pseudo-noise sequence of the pseudo-noise sequence-based scrambling is different for each S-SSB of the one or more additional S-SSBs.

In some examples, to support receiving the one or more additional S-SSBs, the S-SSB communication component 1535 may be configured as or otherwise support a means for receiving the one or more additional S-SSBs whose frequency positions are different from but based on the reference frequency position, where the one or more additional S-SSBs are at least partially discontinuous in frequency.

In some examples, a quantity of S-SSBs is based on a mode of the first UE, where the mode includes a low power indoor mode or a very low power mode, and where the S-SSBs include the reference S-SSBs and the one or more additional S-SSBs.

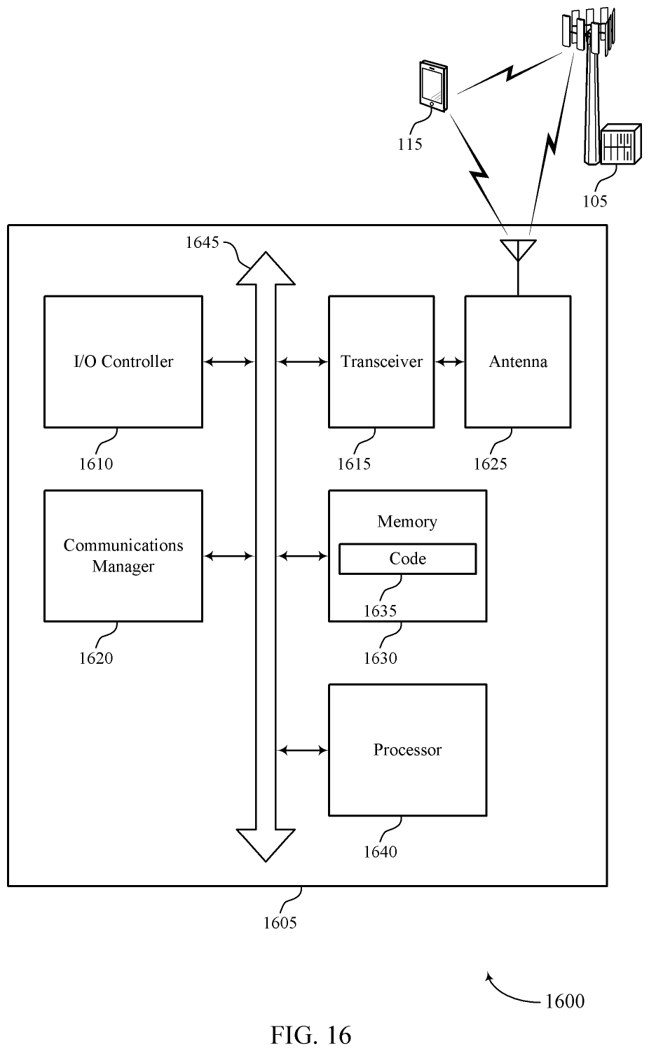

FIG. 16 shows a diagram of a system 1600 including a device 1605 that supports S-SSB transmission in an unlicensed band in accordance with one or more aspects of the present disclosure. The device 1605 may be an example of or include the components of a device 1305, a device 1405, or a UE 115 as described herein. The device 1605 may communicate (e.g., wirelessly) with one or more network entities 105, one or more UEs 115, or any combination thereof. The device 1605 may include components for bi-directional voice and data communications including components for transmitting and receiving communications, such as a communications manager 1620, an input/output (I/O) controller 1610, a transceiver 1615, an antenna 1625, a memory 1630, code 1635, and a processor 1640. These components may be in electronic communication or otherwise coupled (e.g., operatively, communicatively, functionally, electronically, electrically) via one or more buses (e.g., a bus 1645).

The I/O controller 1610 may manage input and output signals for the device 1605. The I/O controller 1610 may also manage peripherals not integrated into the device 1605. In some cases, the I/O controller 1610 may represent a physical connection or port to an external peripheral. In some cases, the I/O controller 1610 may utilize an operating system such as iOS®, ANDROID®, MS-DOS®, MS-WINDOWS®, OS/2®, UNIX®, LINUX®, or another known operating system. Additionally, or alternatively, the I/O controller 1610 may represent or interact with a modem, a keyboard, a mouse, a touchscreen, or a similar device. In some cases, the I/O controller 1610 may be implemented as part of a processor, such as the processor 1640. In some cases, a user may interact with the device 1605 via the I/O controller 1610 or via hardware components controlled by the I/O controller 1610.

In some cases, the device 1605 may include a single antenna 1625. However, in some other cases, the device 1605 may have more than one antenna 1625, which may be capable of concurrently transmitting or receiving multiple wireless transmissions. The transceiver 1615 may communicate bi-directionally, via the one or more antennas 1625, wired, or wireless links as described herein. For example, the transceiver 1615 may represent a wireless transceiver and may communicate bi-directionally with another wireless transceiver. The transceiver 1615 may also include a modem to modulate the packets, to provide the modulated packets to one or more antennas 1625 for transmission, and to demodulate packets received from the one or more antennas 1625. The transceiver 1615, or the transceiver 1615 and one or more antennas 1625, may be an example of a transmitter 1315, a transmitter 1415, a receiver 1310, a receiver 1410, or any combination thereof or component thereof, as described herein.

The memory 1630 may include random access memory (RAM) and read-only memory (ROM). The memory 1630 may store computer-readable, computer-executable code 1635 including instructions that, when executed by the processor 1640, cause the device 1605 to perform various functions described herein. The code 1635 may be stored in a non-transitory computer-readable medium such as system memory or another type of memory. In some cases, the code 1635 may not be directly executable by the processor 1640 but may cause a computer (e.g., when compiled and executed) to perform functions described herein. In some cases, the memory 1630 may contain, among other things, a basic I/O system (BIOS) which may control basic hardware or software operation such as the interaction with peripheral components or devices.

The processor 1640 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1640 may be configured to operate a memory array using a memory controller. In some other cases, a memory controller may be integrated into the processor 1640. The processor 1640 may be configured to execute computer-readable instructions stored in a memory (e.g., the memory 1630) to cause the device 1605 to perform various functions (e.g., functions or tasks supporting S-SSB transmission in an unlicensed band). For example, the device 1605 or a component of the device 1605 may include a processor 1640 and memory 1630 coupled with or to the processor 1640, the processor 1640 and memory 1630 configured to perform various functions described herein.

The communications manager 1620 may support wireless communication at a first UE in accordance with examples as disclosed herein. For example, the communications manager 1620 may be configured as or otherwise support a means for receiving, from a network entity, a message indicating that the first UE is to transmit multiple S-SSBs within an S-SSB period, the message also indicative of whether the multiple S-SSBs are to be transmitted back-to-back or with an offset between consecutive ones of the multiple S-SSBs. The communications manager 1620 may be configured as or otherwise support a means for determining one or more LBT occasions in association with the multiple S-SSBs, where a timing of the one or more LBT occasions is based on whether the multiple S-SSBs are to be transmitted back-to-back or with the offset between the consecutive ones of the multiple S-SSBs. The communications manager 1620 may be configured as or otherwise support a means for participating in at least one LBT procedure during the one or more LBT occasions. The communications manager 1620 may be configured as or otherwise support a means for transmitting, to a second UE, the multiple S-SSBs.

Additionally, or alternatively, the communications manager 1620 may support wireless communication at a first UE in accordance with examples as disclosed herein. For example, the communications manager 1620 may be configured as or otherwise support a means for identifying, via a message, that a second UE is to transmit multiple S-SSBs within an S-SSB period, the message also indicative of whether the multiple S-SSBs are to be transmitted back-to-back or with an offset between consecutive ones of the multiple S-SSBs. The communications manager 1620 may be configured as or otherwise support a means for monitoring for the multiple S-SSBs transmitted by the second UE in accordance with the message. The communications manager 1620 may be configured as or otherwise support a means for receiving, from the second UE, at least one of the multiple S-SSBs.

Additionally, or alternatively, the communications manager 1620 may support wireless communication at a first UE in accordance with examples as disclosed herein. For example, the communications manager 1620 may be configured as or otherwise support a means for identifying a reference frequency position of a reference S-SSB in a sidelink BWP. The communications manager 1620 may be configured as or otherwise support a means for transmitting, to a second UE, the reference S-SSB in accordance with the reference frequency position. The communications manager 1620 may be configured as or otherwise support a means for transmitting, to the second UE, one or more additional S-SSBs whose frequency positions are different from but based on the reference frequency position.

Additionally, or alternatively, the communications manager 1620 may support wireless communication at a first UE in accordance with examples as disclosed herein. For example, the communications manager 1620 may be configured as or otherwise support a means for identifying a reference frequency position of a reference S-SSB in a sidelink BWP. The communications manager 1620 may be configured as or otherwise support a means for receiving, from a second UE, the reference S-SSB in accordance with the reference frequency position. The communications manager 1620 may be configured as or otherwise support a means for receiving, from the second UE, one or more additional S-SSBs whose frequency positions are different from but based on the reference frequency position.

By including or configuring the communications manager 1620 in accordance with examples as described herein, the device 1605 may support techniques for transmitting S-SSB repetitions in an unlicensed band, which may increase the signal strength of S-SSB transmissions, thereby increasing the success rates of the transmissions.

In some examples, the communications manager 1620 may be configured to perform various operations (e.g., receiving, monitoring, transmitting) using or otherwise in cooperation with the transceiver 1615, the one or more antennas 1625, or any combination thereof. Although the communications manager 1620 is illustrated as a separate component, in some examples, one or more functions described with reference to the communications manager 1620 may be supported by or performed by the processor 1640, the memory 1630, the code 1635, or any combination thereof. For example, the code 1635 may include instructions executable by the processor 1640 to cause the device 1605 to perform various aspects of S-SSB transmission in an unlicensed band as described herein, or the processor 1640 and the memory 1630 may be otherwise configured to perform or support such operations.

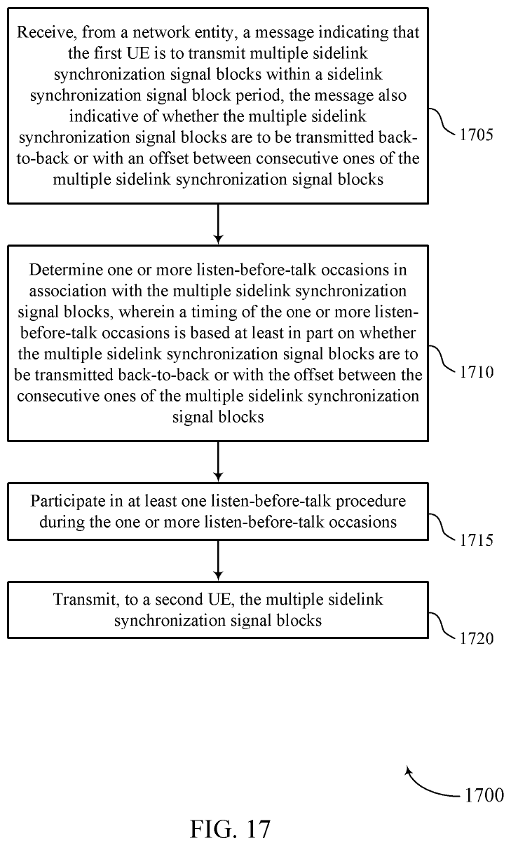

FIG. 17 shows a flowchart illustrating a method 1700 that supports S-SSB transmission in an unlicensed band in accordance with one or more aspects of the present disclosure. The operations of the method 1700 may be implemented by a UE or its components as described herein. For example, the operations of the method 1700 may be performed by a UE 115 as described with reference to FIGS. 1 through 16. In some examples, a UE may execute a set of instructions to control the functional elements of the UE to perform the described functions. Additionally, or alternatively, the UE may perform aspects of the described functions using special-purpose hardware.

At 1705, the method may include receiving, from a network entity, a message indicating that the first UE is to transmit multiple S-SSBs within an S-SSB period, the message also indicative of whether the multiple S-SSBs are to be transmitted back-to-back or with an offset between consecutive ones of the multiple S-SSBs. The operations of 1705 may be performed in accordance with examples as disclosed herein. In some examples, aspects of the operations of 1705 may be performed by a message reception component 1525 as described with reference to FIG. 15.

At 1710, the method may include determining one or more LBT occasions in association with the multiple S-SSBs, where a timing of the one or more LBT occasions is based on whether the multiple S-SSBs are to be transmitted back-to-back or with the offset between the consecutive ones of the multiple S-SSBs. The operations of 1710 may be performed in accordance with examples as disclosed herein. In some examples, aspects of the operations of 1710 may be performed by an LBT component 1530 as described with reference to FIG. 15.

At 1715, the method may include participating in at least one LBT procedure during the one or more LBT occasions. The operations of 1715 may be performed in accordance with examples as disclosed herein. In some examples, aspects of the operations of 1715 may be performed by an LBT component 1530 as described with reference to FIG. 15.

At 1720, the method may include transmitting, to a second UE, the multiple S-SSBs. The operations of 1720 may be performed in accordance with examples as disclosed herein. In some examples, aspects of the operations of 1720 may be performed by an S-SSB communication component 1535 as described with reference to FIG. 15.

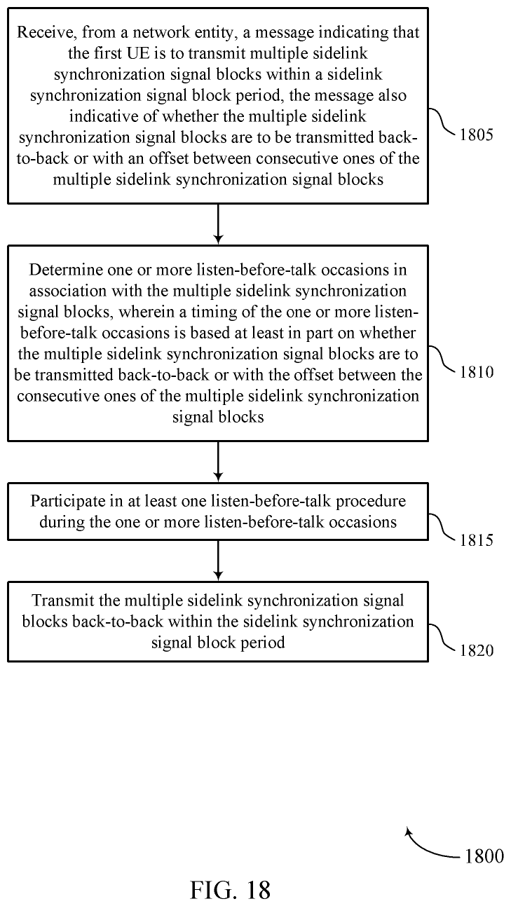

FIG. 18 shows a flowchart illustrating a method 1800 that supports S-SSB transmission in an unlicensed band in accordance with one or more aspects of the present disclosure. The operations of the method 1800 may be implemented by a UE or its components as described herein. For example, the operations of the method 1800 may be performed by a UE 115 as described with reference to FIGS. 1 through 16. In some examples, a UE may execute a set of instructions to control the functional elements of the UE to perform the described functions. Additionally, or alternatively, the UE may perform aspects of the described functions using special-purpose hardware.

At 1805, the method may include receiving, from a network entity, a message indicating that the first UE is to transmit multiple S-SSBs within an S-SSB period, the message also indicative of whether the multiple S-SSBs are to be transmitted back-to-back or with an offset between consecutive ones of the multiple S-SSBs. The operations of 1805 may be performed in accordance with examples as disclosed herein. In some examples, aspects of the operations of 1805 may be performed by a message reception component 1525 as described with reference to FIG. 15.

At 1810, the method may include determining one or more LBT occasions in association with the multiple S-SSBs, where a timing of the one or more LBT occasions is based on whether the multiple S-SSBs are to be transmitted back-to-back or with the offset between the consecutive ones of the multiple S-SSBs. The operations of 1810 may be performed in accordance with examples as disclosed herein. In some examples, aspects of the operations of 1810 may be performed by an LBT component 1530 as described with reference to FIG. 15.

At 1815, the method may include participating in at least one LBT procedure during the one or more LBT occasions. The operations of 1815 may be performed in accordance with examples as disclosed herein. In some examples, aspects of the operations of 1815 may be performed by an LBT component 1530 as described with reference to FIG. 15.

At 1820, the method may include transmitting the multiple S-SSBs back-to-back within the S-SSB period. The operations of 1820 may be performed in accordance with examples as disclosed herein. In some examples, aspects of the operations of 1820 may be performed by an S-SSB communication component 1535 as described with reference to FIG. 15.

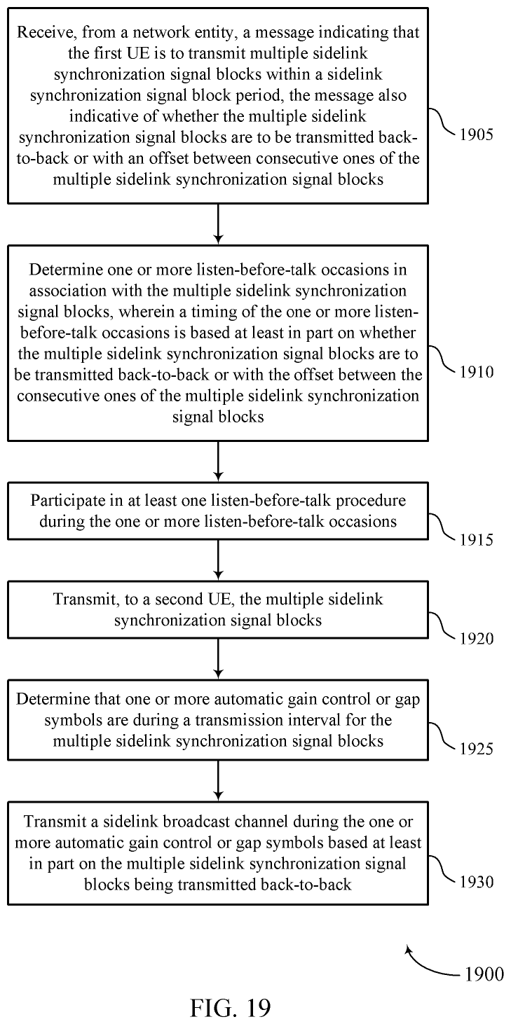

FIG. 19 shows a flowchart illustrating a method 1900 that supports S-SSB transmission in an unlicensed band in accordance with one or more aspects of the present disclosure. The operations of the method 1900 may be implemented by a UE or its components as described herein. For example, the operations of the method 1900 may be performed by a UE 115 as described with reference to FIGS. 1 through 16. In some examples, a UE may execute a set of instructions to control the functional elements of the UE to perform the described functions. Additionally, or alternatively, the UE may perform aspects of the described functions using special-purpose hardware.

At 1905, the method may include receiving, from a network entity, a message indicating that the first UE is to transmit multiple S-SSBs within an S-SSB period, the message also indicative of whether the multiple S-SSBs are to be transmitted back-to-back or with an offset between consecutive ones of the multiple S-SSBs. The operations of 1905 may be performed in accordance with examples as disclosed herein. In some examples, aspects of the operations of 1905 may be performed by a message reception component 1525 as described with reference to FIG. 15.

At 1910, the method may include determining one or more LBT occasions in association with the multiple S-SSBs, where a timing of the one or more LBT occasions is based on whether the multiple S-SSBs are to be transmitted back-to-back or with the offset between the consecutive ones of the multiple S-SSBs. The operations of 1910 may be performed in accordance with examples as disclosed herein. In some examples, aspects of the operations of 1910 may be performed by an LBT component 1530 as described with reference to FIG. 15.

At 1915, the method may include participating in at least one LBT procedure during the one or more LBT occasions. The operations of 1915 may be performed in accordance with examples as disclosed herein. In some examples, aspects of the operations of 1915 may be performed by an LBT component 1530 as described with reference to FIG. 15.

At 1920, the method may include transmitting, to a second UE, the multiple S-SSBs. The operations of 1920 may be performed in accordance with examples as disclosed herein. In some examples, aspects of the operations of 1920 may be performed by an S-SSB communication component 1535 as described with reference to FIG. 15.

At 1925, the method may include determining that one or more AGC or gap symbols are during a transmission interval for the multiple S-SSBs. The operations of 1925 may be performed in accordance with examples as disclosed herein. In some examples, aspects of the operations of 1925 may be performed by an S-SSB communication component 1535 as described with reference to FIG. 15.

At 1930, the method may include transmitting a sidelink broadcast channel during the one or more AGC or gap symbols based on the multiple S-SSBs being transmitted back-to-back. The operations of 1930 may be performed in accordance with examples as disclosed herein. In some examples, aspects of the operations of 1930 may be performed by an S-SSB communication component 1535 as described with reference to FIG. 15.

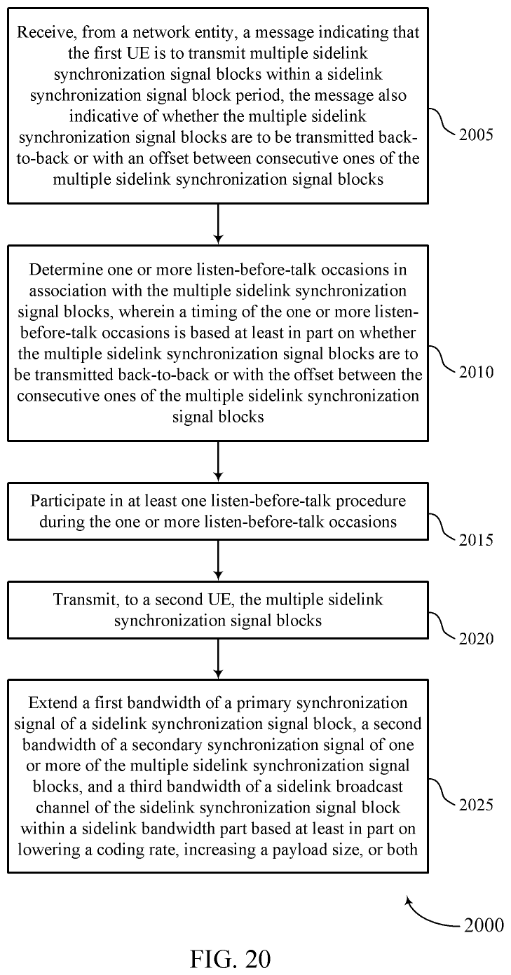

FIG. 20 shows a flowchart illustrating a method 2000 that supports S-SSB transmission in an unlicensed band in accordance with one or more aspects of the present disclosure. The operations of the method 2000 may be implemented by a UE or its components as described herein. For example, the operations of the method 2000 may be performed by a UE 115 as described with reference to FIGS. 1 through 16. In some examples, a UE may execute a set of instructions to control the functional elements of the UE to perform the described functions. Additionally, or alternatively, the UE may perform aspects of the described functions using special-purpose hardware.

At 2005, the method may include receiving, from a network entity, a message indicating that the first UE is to transmit multiple S-SSBs within an S-SSB period, the message also indicative of whether the multiple S-SSBs are to be transmitted back-to-back or with an offset between consecutive ones of the multiple S-SSBs. The operations of 2005 may be performed in accordance with examples as disclosed herein. In some examples, aspects of the operations of 2005 may be performed by a message reception component 1525 as described with reference to FIG. 15.

At 2010, the method may include determining one or more LBT occasions in association with the multiple S-SSBs, where a timing of the one or more LBT occasions is based on whether the multiple S-SSBs are to be transmitted back-to-back or with the offset between the consecutive ones of the multiple S-SSBs. The operations of 2010 may be performed in accordance with examples as disclosed herein. In some examples, aspects of the operations of 2010 may be performed by an LBT component 1530 as described with reference to FIG. 15.

At 2015, the method may include participating in at least one LBT procedure during the one or more LBT occasions. The operations of 2015 may be performed in accordance with examples as disclosed herein. In some examples, aspects of the operations of 2015 may be performed by an LBT component 1530 as described with reference to FIG. 15.

At 2020, the method may include transmitting, to a second UE, the multiple S-SSBs. The operations of 2020 may be performed in accordance with examples as disclosed herein. In some examples, aspects of the operations of 2020 may be performed by an S-SSB communication component 1535 as described with reference to FIG. 15.

At 2025, the method may include extending a first bandwidth of a PSS of an S-SSB, a second bandwidth of an SSS of one or more of the multiple S-SSBs, and a third bandwidth of a sidelink broadcast channel of the S-SSB within a sidelink BWP based on lowering a coding rate, increasing a payload size, or both. The operations of 2025 may be performed in accordance with examples as disclosed herein. In some examples, aspects of the operations of 2025 may be performed by a bandwidth extension component 1565 as described with reference to FIG. 15.

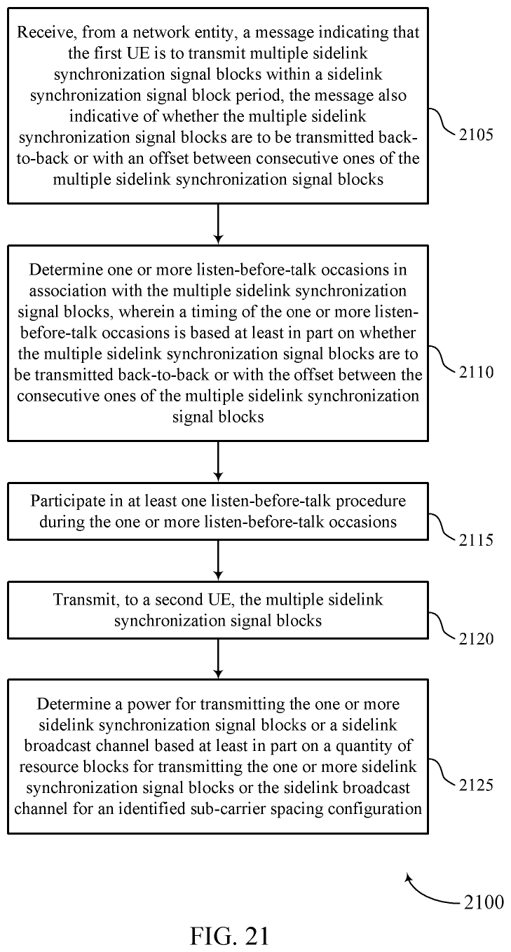

FIG. 21 shows a flowchart illustrating a method 2100 that supports S-SSB transmission in an unlicensed band in accordance with one or more aspects of the present disclosure. The operations of the method 2100 may be implemented by a UE or its components as described herein. For example, the operations of the method 2100 may be performed by a UE 115 as described with reference to FIGS. 1 through 16. In some examples, a UE may execute a set of instructions to control the functional elements of the UE to perform the described functions. Additionally, or alternatively, the UE may perform aspects of the described functions using special-purpose hardware.

At 2105, the method may include receiving, from a network entity, a message indicating that the first UE is to transmit multiple S-SSBs within an S-SSB period, the message also indicative of whether the multiple S-SSBs are to be transmitted back-to-back or with an offset between consecutive ones of the multiple S-SSBs. The operations of 2105 may be performed in accordance with examples as disclosed herein. In some examples, aspects of the operations of 2105 may be performed by a message reception component 1525 as described with reference to FIG. 15.

At 2110, the method may include determining one or more LBT occasions in association with the multiple S-SSBs, where a timing of the one or more LBT occasions is based on whether the multiple S-SSBs are to be transmitted back-to-back or with the offset between the consecutive ones of the multiple S-SSBs. The operations of 2110 may be performed in accordance with examples as disclosed herein. In some examples, aspects of the operations of 2110 may be performed by an LBT component 1530 as described with reference to FIG. 15.

At 2115, the method may include participating in at least one LBT procedure during the one or more LBT occasions. The operations of 2115 may be performed in accordance with examples as disclosed herein. In some examples, aspects of the operations of 2115 may be performed by an LBT component 1530 as described with reference to FIG. 15.

At 2120, the method may include transmitting, to a second UE, the multiple S-SSBs. The operations of 2120 may be performed in accordance with examples as disclosed herein. In some examples, aspects of the operations of 2120 may be performed by an S-SSB communication component 1535 as described with reference to FIG. 15.

At 2125, the method may include determining a power for transmitting the one or more S-SSBs or a sidelink broadcast channel based on a quantity of resource blocks for transmitting the one or more S-SSBs or the sidelink broadcast channel for an identified sub-carrier spacing configuration. The operations of 2125 may be performed in accordance with examples as disclosed herein. In some examples, aspects of the operations of 2125 may be performed by a power determination component 1570 as described with reference to FIG. 15.

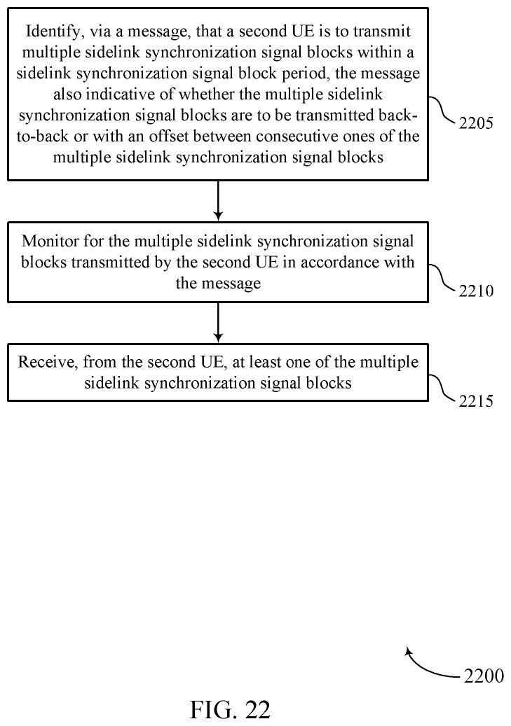

FIG. 22 shows a flowchart illustrating a method 2200 that supports S-SSB transmission in an unlicensed band in accordance with one or more aspects of the present disclosure. The operations of the method 2200 may be implemented by a UE or its components as described herein. For example, the operations of the method 2200 may be performed by a UE 115 as described with reference to FIGS. 1 through 16. In some examples, a UE may execute a set of instructions to control the functional elements of the UE to perform the described functions. Additionally, or alternatively, the UE may perform aspects of the described functions using special-purpose hardware.

At 2205, the method may include identifying, via a message, that a second UE is to transmit multiple S-SSBs within an S-SSB period, the message also indicative of whether the multiple S-SSBs are to be transmitted back-to-back or with an offset between consecutive ones of the multiple S-SSBs. The operations of 2205 may be performed in accordance with examples as disclosed herein. In some examples, aspects of the operations of 2205 may be performed by an S-SSB identification component 1540 as described with reference to FIG. 15.

At 2210, the method may include monitoring for the multiple S-SSBs transmitted by the second UE in accordance with the message. The operations of 2210 may be performed in accordance with examples as disclosed herein. In some examples, aspects of the operations of 2210 may be performed by a monitoring component 1545 as described with reference to FIG. 15.

At 2215, the method may include receiving, from the second UE, at least one of the multiple S-SSBs. The operations of 2215 may be performed in accordance with examples as disclosed herein. In some examples, aspects of the operations of 2215 may be performed by an S-SSB communication component 1535 as described with reference to FIG. 15.

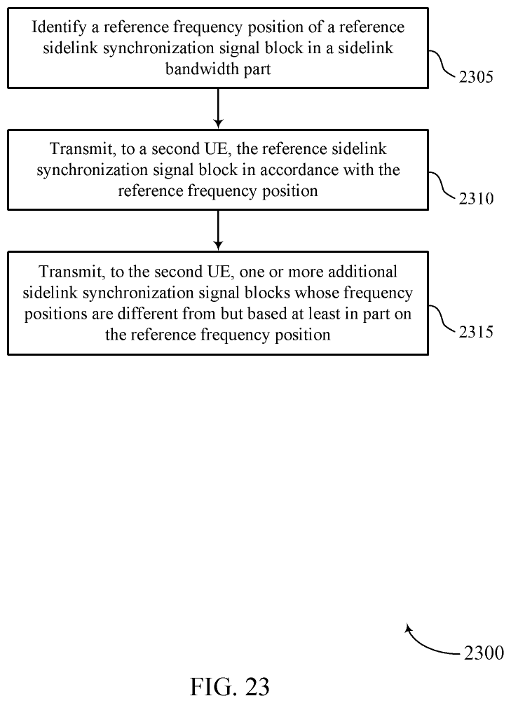

FIG. 23 shows a flowchart illustrating a method 2300 that supports S-SSB transmission in an unlicensed band in accordance with one or more aspects of the present disclosure. The operations of the method 2300 may be implemented by a UE or its components as described herein. For example, the operations of the method 2300 may be performed by a UE 115 as described with reference to FIGS. 1 through 16. In some examples, a UE may execute a set of instructions to control the functional elements of the UE to perform the described functions. Additionally, or alternatively, the UE may perform aspects of the described functions using special-purpose hardware.

At 2305, the method may include identifying a reference frequency position of a reference S-SSB in a sidelink BWP. The operations of 2305 may be performed in accordance with examples as disclosed herein. In some examples, aspects of the operations of 2305 may be performed by a reference frequency position component 1550 as described with reference to FIG. 15.

At 2310, the method may include transmitting, to a second UE, the reference S-SSB in accordance with the reference frequency position. The operations of 2310 may be performed in accordance with examples as disclosed herein. In some examples, aspects of the operations of 2310 may be performed by a reference S-SSB component 1555 as described with reference to FIG. 15.

At 2315, the method may include transmitting, to the second UE, one or more additional S-SSBs whose frequency positions are different from but based on the reference frequency position. The operations of 2315 may be performed in accordance with examples as disclosed herein. In some examples, aspects of the operations of 2315 may be performed by an S-SSB communication component 1535 as described with reference to FIG. 15.

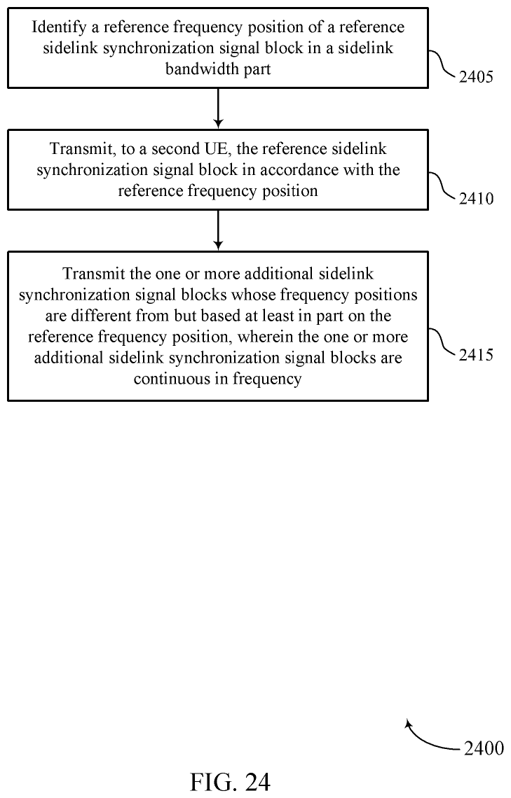

FIG. 24 shows a flowchart illustrating a method 2400 that supports S-SSB transmission in an unlicensed band in accordance with one or more aspects of the present disclosure. The operations of the method 2400 may be implemented by a UE or its components as described herein. For example, the operations of the method 2400 may be performed by a UE 115 as described with reference to FIGS. 1 through 16. In some examples, a UE may execute a set of instructions to control the functional elements of the UE to perform the described functions. Additionally, or alternatively, the UE may perform aspects of the described functions using special-purpose hardware.

At 2405, the method may include identifying a reference frequency position of a reference S-SSB in a sidelink BWP. The operations of 2405 may be performed in accordance with examples as disclosed herein. In some examples, aspects of the operations of 2405 may be performed by a reference frequency position component 1550 as described with reference to FIG. 15.

At 2410, the method may include transmitting, to a second UE, the reference S-SSB in accordance with the reference frequency position. The operations of 2410 may be performed in accordance with examples as disclosed herein. In some examples, aspects of the operations of 2410 may be performed by a reference S-SSB component 1555 as described with reference to FIG. 15.

At 2415, the method may include transmitting the one or more additional S-SSBs whose frequency positions are different from but based on the reference frequency position, where the one or more additional S-SSBs are continuous in frequency. The operations of 2415 may be performed in accordance with examples as disclosed herein. In some examples, aspects of the operations of 2415 may be performed by an S-SSB communication component 1535 as described with reference to FIG. 15.

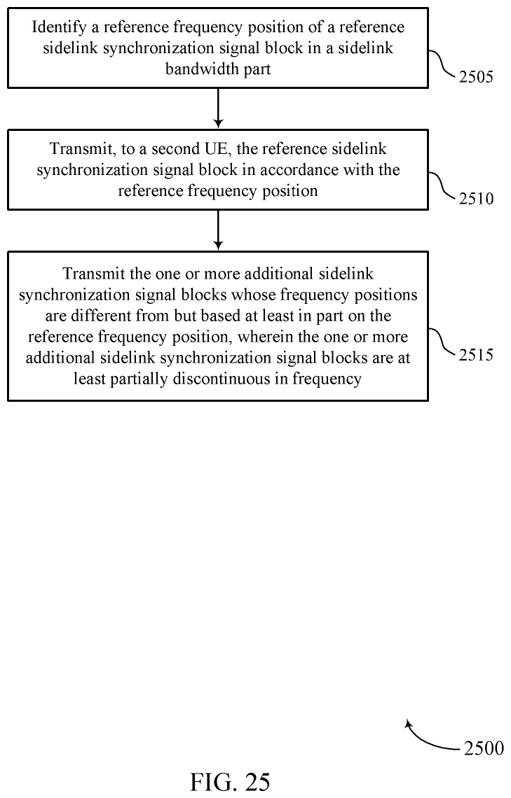

FIG. 25 shows a flowchart illustrating a method 2500 that supports S-SSB transmission in an unlicensed band in accordance with one or more aspects of the present disclosure. The operations of the method 2500 may be implemented by a UE or its components as described herein. For example, the operations of the method 2500 may be performed by a UE 115 as described with reference to FIGS. 1 through 16. In some examples, a UE may execute a set of instructions to control the functional elements of the UE to perform the described functions. Additionally, or alternatively, the UE may perform aspects of the described functions using special-purpose hardware.

At 2505, the method may include identifying a reference frequency position of a reference S-SSB in a sidelink BWP. The operations of 2505 may be performed in accordance with examples as disclosed herein. In some examples, aspects of the operations of 2505 may be performed by a reference frequency position component 1550 as described with reference to FIG. 15.

At 2510, the method may include transmitting, to a second UE, the reference S-SSB in accordance with the reference frequency position. The operations of 2510 may be performed in accordance with examples as disclosed herein. In some examples, aspects of the operations of 2510 may be performed by a reference S-SSB component 1555 as described with reference to FIG. 15.

At 2515, the method may include transmitting the one or more additional S-SSBs whose frequency positions are different from but based on the reference frequency position, where the one or more additional S-SSBs are at least partially discontinuous in frequency. The operations of 2515 may be performed in accordance with examples as disclosed herein. In some examples, aspects of the operations of 2515 may be performed by an S-SSB communication component 1535 as described with reference to FIG. 15.

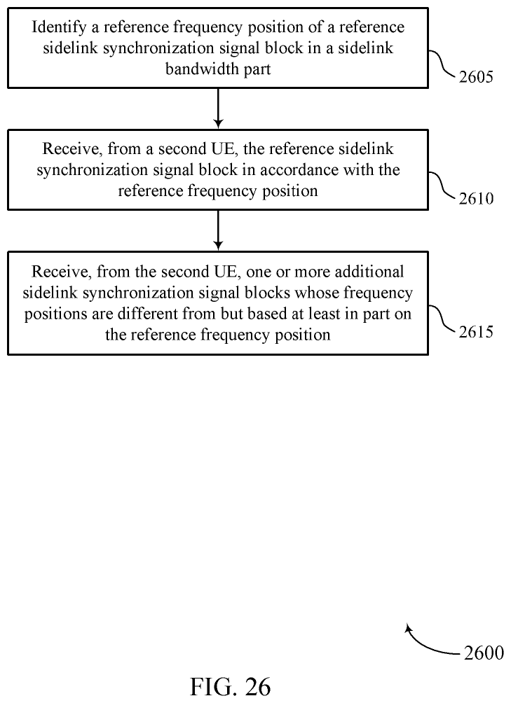

FIG. 26 shows a flowchart illustrating a method 2600 that supports S-SSB transmission in an unlicensed band in accordance with one or more aspects of the present disclosure. The operations of the method 2600 may be implemented by a UE or its components as described herein. For example, the operations of the method 2600 may be performed by a UE 115 as described with reference to FIGS. 1 through 16. In some examples, a UE may execute a set of instructions to control the functional elements of the UE to perform the described functions. Additionally, or alternatively, the UE may perform aspects of the described functions using special-purpose hardware.

At 2605, the method may include identifying a reference frequency position of a reference S-SSB in a sidelink BWP. The operations of 2605 may be performed in accordance with examples as disclosed herein. In some examples, aspects of the operations of 2605 may be performed by a reference frequency position component 1550 as described with reference to FIG. 15.

At 2610, the method may include receiving, from a second UE, the reference S-SSB in accordance with the reference frequency position. The operations of 2610 may be performed in accordance with examples as disclosed herein. In some examples, aspects of the operations of 2610 may be performed by a reference S-SSB component 1555 as described with reference to FIG. 15.

At 2615, the method may include receiving, from the second UE, one or more additional S-SSBs whose frequency positions are different from but based on the reference frequency position. The operations of 2615 may be performed in accordance with examples as disclosed herein. In some examples, aspects of the operations of 2615 may be performed by an S-SSB communication component 1535 as described with reference to FIG. 15.

The following provides an overview of aspects of the present disclosure:

Aspect 1: A method for wireless communication at a first UE, comprising: receiving, from a network entity, a message indicating that the first UE is to transmit multiple S-SSBs within an S-SSB period, the message also indicative of whether the multiple S-SSBs are to be transmitted back-to-back or with an offset between consecutive ones of the multiple S-SSBs; determining one or more LBT occasions in association with the multiple S-SSBs, wherein a timing of the one or more LBT occasions is based at least in part on whether the multiple S-SSBs are to be transmitted back-to-back or with the offset between the consecutive ones of the multiple S-SSBs; participating in at least one LBT procedure during the one or more LBT occasions; and transmitting, to a second UE, the multiple S-SSBs.

Aspect 2: The method of aspect 1, wherein receiving the message indicating that the first UE is to transmit multiple S-SSBs within the S-SSB period comprises: receiving an indication of a sidelink configuration, the sidelink configuration indicating that the first UE is to transmit the multiple S-SSBs within an S-SSB instance of the S-SSB period.

Aspect 3: The method of aspect 2, further comprising: determining, based at least on an RRC parameter of the sidelink configuration, a determined quantity of the multiple S-SSBs for inclusion within the S-SSB instance.

Aspect 4: The method of any of aspects 2 through 3, wherein the sidelink configuration defines an interval between starting times of consecutive S-SSB instances, wherein the interval allows for the multiple S-SSBs to be included within a first S-SSB instance without overlapping a second S-SSB instance of the consecutive S-SSB instances.

Aspect 5: The method of any of aspects 2 through 4, wherein the sidelink configuration indicating that the multiple S-SSBs are to transmitted within the S-SSB instance is indicative that the multiple S-SSBs are to be transmitted back-to-back.

Aspect 6: The method of any of aspects 1 through 5, wherein receiving the message indicating that the first UE is to transmit multiple S-SSBs within the S-SSB period comprises: receiving an indication of a sidelink configuration, the sidelink configuration indicating that the first UE is to transmit the multiple S-SSBs within a corresponding multiple S-SSB instances of the S-SSB period.

Aspect 7: The method of any of aspects 1 through 6, wherein transmitting the multiple S-SSBs comprises: transmitting the multiple S-SSBs back-to-back within the S-SSB period.

Aspect 8: The method of aspect 7, wherein determining the one or more LBT occasions further comprises: identifying a first LBT occasion associated with a temporally first of the multiple S-SSBs, wherein the at least one LBT occasion during which the first UE participates in the listen-to-talk procedure is the first LBT occasion, the transmitting of the multiple S-SSBs based at least in part on the first UE participating in the LBT procedure during only the first LBT occasion.

Aspect 9: The method of any of aspects 7 through 8, wherein determining the one or more LBT occasions further comprises: identifying a first LBT occasion associated with a temporally first of the multiple S-SSBs, wherein the first UE participates in an unsuccessful LBT procedure during the first LBT occasion; and identifying one or more additional LBT occasions that temporally follow the first LBT occasion, wherein the at least one LBT occasion during which the first UE participates in the listen-to-talk procedure includes one of the one or more additional LBT occasions after also participating in the unsuccessful LBT procedure.

Aspect 10: The method of aspect 9, further comprising: determining, based at least in part on the message, a quantity of the multiple S-SSBs for transmission, wherein less than the quantity is transmitted based at least in part on the first UE participating in the unsuccessful LBT procedure during the first LBT occasion.

Aspect 11: The method of any of aspects 7 through 10, further comprising: determining that one or more AGC or gap symbols are during a transmission interval for the multiple S-SSBs; and transmitting a sidelink broadcast channel during the one or more AGC or gap symbols based at least in part on the multiple S-SSBs being transmitted back-to-back.

Aspect 12: The method of aspect 11, wherein transmitting the sidelink broadcast channel comprises: transmitting the sidelink broadcast channel during a gap symbol by including resource elements of the gap symbol in rate matching or by duplicating a previously transmitted sidelink broadcast channel.

Aspect 13: The method of any of aspects 1 through 12, wherein transmitting the multiple S-SSBs comprises: transmitting the multiple S-SSBs with the offset between consecutive ones of the multiple S-SSBs.

Aspect 14: The method of aspect 13, wherein determining the one or more LBT occasions further comprises: identifying a plurality of LBT occasions, each associated with one of the multiple S-SSBs, the transmitting of the multiple S-SSBs based at least in part on the first UE participating in the LBT procedure during multiple ones of the plurality of LBT occasions.

Aspect 15: The method of any of aspects 1 through 14, further comprising: extending a first bandwidth of a PSS of an S-SSB, a second bandwidth of an SSS of one or more of the multiple S-SSBs, and a third bandwidth of a sidelink broadcast channel of the S-SSB within a sidelink BWP based at least in part on lowering a coding rate, increasing a payload size, or both.

Aspect 16: The method of any of aspects 1 through 15, further comprising: determining a power for transmitting the one or more S-SSBs or a sidelink broadcast channel based at least in part on a quantity of resource blocks for transmitting the one or more S-SSBs or the sidelink broadcast channel for an identified sub-carrier spacing configuration.

Aspect 17: A method for wireless communication at a first UE, comprising: identifying, via a message, that a second UE is to transmit multiple S-SSBs within an S-SSB period, the message also indicative of whether the multiple S-SSBs are to be transmitted back-to-back or with an offset between consecutive ones of the multiple S-SSBs; monitoring for the multiple S-SSBs transmitted by the second UE in accordance with the message; and receiving, from the second UE, at least one of the multiple S-SSBs.

Aspect 18: The method of aspect 17, wherein identifying that the second UE is to transmit multiple S-SSBs within the S-SSB period comprises: receiving an indication of a sidelink configuration, the sidelink configuration indicating that the second UE is to transmit the multiple S-SSBs within an S-SSB instance of the S-SSB period.

Aspect 19: The method of aspect 18, wherein the sidelink configuration defines an interval between starting times of consecutive S-SSB instances, wherein the interval allows for the multiple S-SSBs to be included within a first S-SSB instance without overlapping a second S-SSB instance of the consecutive S-SSB instances.

Aspect 20: The method of any of aspects 18 through 19, wherein the sidelink configuration indicating that the multiple S-SSBs are to transmitted within the S-SSB instance is indicative that the multiple S-SSBs are to be transmitted back-to-back.

Aspect 21: The method of any of aspects 17 through 20, wherein identifying that the second UE is to transmit multiple S-SSBs within the S-SSB period comprises: receiving an indication of a sidelink configuration, the sidelink configuration indicating that the second UE is to transmit the multiple S-SSBs within a corresponding multiple S-SSB instances of the S-SSB period.

Aspect 22: The method of any of aspects 17 through 21, wherein receiving at least one of the multiple S-SSBs comprises: receiving a plurality of the multiple S-SSBs back-to-back within the S-SSB period.

Aspect 23: The method of aspect 22, further comprising: receiving a sidelink broadcast channel during one or more AGC or gap symbols based at least in part on the multiple S-SSBs being received back-to-back.

Aspect 24: The method of any of aspects 17 through 23, wherein receiving at least one of the multiple S-SSBs comprises: receiving a plurality of the multiple S-SSBs with the offset between consecutive ones of the multiple S-SSBs.

Aspect 25: The method of any of aspects 17 through 24, wherein receiving at least one of the multiple S-SSBs comprises: blind detecting for the multiple S-SSBs; and determining that a received signal is one of the multiple S-SSBs based at least in part on a comparison of a correlation energy of the received signal with a threshold.

Aspect 26: A method for wireless communication at a first UE, comprising: identifying a reference frequency position of a reference S-SSB in a sidelink BWP; transmitting, to a second UE, the reference S-SSB in accordance with the reference frequency position; and transmitting, to the second UE, one or more additional S-SSBs whose frequency positions are different from but based at least in part on the reference frequency position.

Aspect 27: The method of aspect 26, further comprising: receiving, from a network entity, a message indicating the reference frequency position of the reference S-SSB in the sidelink BWP.

Aspect 28: The method of any of aspects 26 through 27, wherein transmitting the one or more additional S-SSBs comprises: transmitting the one or more additional S-SSBs whose frequency positions are different from but based at least in part on the reference frequency position, wherein the one or more additional S-SSBs are continuous in frequency.

Aspect 29: The method of aspect 28, further comprising: receiving, from a network entity, signaling indicating a sub-carrier spacing configuration, the sub-carrier spacing configuration indicative of a quantity of S-SSBs to be transmitted in the sidelink BWP by the first UE, the S-SSBs comprising the reference S-SSB and the one or more additional S-SSBs; and identifying the quantity of S-SSBs to be transmitted in the sidelink BWP by the first UE based at least in part on receiving the signaling.

Aspect 30: The method of any of aspects 28 through 29, further comprising: receiving, from a network entity, signaling indicating a quantity of S-SSBs to be transmitted in the sidelink BWP by the first UE, the S-SSBs comprising the reference S-SSB and the one or more additional S-SSBs.

Aspect 31: The method of any of aspects 28 through 30, further comprising: identifying a quantity of S-SSBs to be transmitted in the sidelink BWP by the first UE, wherein the quantity of S-SSBs is pre-configured, and wherein the S-SSBs comprise the reference S-SSB and the one or more additional S-SSBs.

Aspect 32: The method of any of aspects 26 through 31, wherein transmitting the one or more additional S-SSBs comprises: transmitting the one or more additional S-SSBs whose frequency positions are different from but based at least in part on the reference frequency position, wherein the one or more additional S-SSBs are at least partially discontinuous in frequency.

Aspect 33: The method of aspect 32, wherein a quantity of S-SSBs is based at least in part on a mode of the first UE, wherein the mode comprises a low power indoor mode or a very low power mode, and wherein the S-SSBs comprise the reference S-SSBs and the one or more additional S-SSBs.

Aspect 34: The method of any of aspects 32 through 33, further comprising: receiving, from a network entity, signaling indicating a bitmap indicative of a quantity of S-SSBs to be transmitted in the sidelink BWP by the first UE, the S-SSBs comprising the reference S-SSB and the one or more additional S-SSBs, and wherein a first bit of the bitmap corresponds to the reference S-SSB.

Aspect 35: The method of any of aspects 26 through 34, further comprising: extending a first bandwidth of a PSS of an S-SSB, a second bandwidth of an SSS of one or more multiple S-SSBs, and a third bandwidth of a sidelink broadcast channel of the S-SSB within a sidelink BWP based at least in part on lowering a coding rate, increasing a payload size, or both.

Aspect 36: The method of any of aspects 26 through 35, further comprising: determining a power for transmitting an S-SSB or a sidelink broadcast channel based at least in part on a quantity of resource blocks for transmitting the S-SSB or the sidelink broadcast channel with a sub-carrier spacing configuration.

Aspect 37: A method for wireless communication at a first UE, comprising: identifying a reference frequency position of a reference S-SSB in a sidelink BWP; receiving, from a second UE, the reference S-SSB in accordance with the reference frequency position; and receiving, from the second UE, one or more additional S-SSBs whose frequency positions are different from but based at least in part on the reference frequency position.

Aspect 38: The method of aspect 37, further comprising: receiving, from a network entity, a message indicating the reference frequency position of the reference S-SSB in the sidelink BWP.

Aspect 39: The method of any of aspects 37 through 38, wherein receiving the one or more additional S-SSBs comprises: receiving the one or more additional S-SSBs whose frequency positions are different from but based at least in part on the reference frequency position, wherein the one or more additional S-SSBs are continuous in frequency.

Aspect 40: The method of aspect 39, further comprising: decoding the one or more additional S-SSBs to identify pseudo-noise sequence-based scrambling added to each S-SSB of the one or more additional S-SSBs, wherein a pseudo-noise sequence of the pseudo-noise sequence-based scrambling is different for each S-SSB of the one or more additional S-SSBs.

Aspect 41: The method of any of aspects 37 through 40, wherein receiving the one or more additional S-SSBs comprises: receiving the one or more additional S-SSBs whose frequency positions are different from but based at least in part on the reference frequency position, wherein the one or more additional S-SSBs are at least partially discontinuous in frequency.

Aspect 42: The method of aspect 41, wherein a quantity of S-SSBs is based at least in part on a mode of the first UE, wherein the mode comprises a low power indoor mode or a very low power mode, and wherein the S-SSBs comprise the reference S-SSBs and the one or more additional S-SSBs.

Aspect 43: An apparatus for wireless communication at a first UE, comprising a processor; memory coupled with the processor; and instructions stored in the memory and executable by the processor to cause the apparatus to perform a method of any of aspects 1 through 16.

Aspect 44: An apparatus for wireless communication at a first UE, comprising at least one means for performing a method of any of aspects 1 through 16.

Aspect 45: A non-transitory computer-readable medium storing code for wireless communication at a first UE, the code comprising instructions executable by a processor to perform a method of any of aspects 1 through 16.

Aspect 46: An apparatus for wireless communication at a first UE, comprising a processor; memory coupled with the processor; and instructions stored in the memory and executable by the processor to cause the apparatus to perform a method of any of aspects 17 through 25.

Aspect 47: An apparatus for wireless communication at a first UE, comprising at least one means for performing a method of any of aspects 17 through 25.

Aspect 48: A non-transitory computer-readable medium storing code for wireless communication at a first UE, the code comprising instructions executable by a processor to perform a method of any of aspects 17 through 25.

Aspect 49: An apparatus for wireless communication at a first UE, comprising a processor; memory coupled with the processor; and instructions stored in the memory and executable by the processor to cause the apparatus to perform a method of any of aspects 26 through 36.

Aspect 50: An apparatus for wireless communication at a first UE, comprising at least one means for performing a method of any of aspects 26 through 36.

Aspect 51: A non-transitory computer-readable medium storing code for wireless communication at a first UE, the code comprising instructions executable by a processor to perform a method of any of aspects 26 through 36.

Aspect 52: An apparatus for wireless communication at a first UE, comprising a processor; memory coupled with the processor; and instructions stored in the memory and executable by the processor to cause the apparatus to perform a method of any of aspects 37 through 42.

Aspect 53: An apparatus for wireless communication at a first UE, comprising at least one means for performing a method of any of aspects 37 through 42.

Aspect 54: A non-transitory computer-readable medium storing code for wireless communication at a first UE, the code comprising instructions executable by a processor to perform a method of any of aspects 37 through 42.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a first user equipment (UE), comprising:
receiving, from a network entity, a message indicating that the first UE is to transmit multiple sidelink synchronization signal blocks within a sidelink synchronization signal block period, the message also indicative of whether the multiple sidelink synchronization signal blocks are to be transmitted back-to-back or with an offset between consecutive ones of the multiple sidelink synchronization signal blocks;
determining one or more listen-before-talk occasions in association with the multiple sidelink synchronization signal blocks, wherein a timing of the one or more listen-before-talk occasions is based at least in part on whether the multiple sidelink synchronization signal blocks are to be transmitted back-to-back or with the offset between the consecutive ones of the multiple sidelink synchronization signal blocks;
participating in at least one listen-before-talk procedure during the one or more listen-before-talk occasions; and
transmitting, to a second UE, the multiple sidelink synchronization signal blocks.

2. The method of claim 1, wherein receiving the message indicating that the first UE is to transmit multiple sidelink synchronization signal blocks within the sidelink synchronization signal block period comprises:
receiving an indication of a sidelink configuration, the sidelink configuration indicating that the first UE is to transmit the multiple sidelink synchronization signal blocks within a sidelink synchronization signal block instance of the sidelink synchronization signal block period.

3. The method of claim 2, further comprising:
determining, based at least on a radio resource control parameter of the sidelink configuration, a determined quantity of the multiple sidelink synchronization signal blocks for inclusion within the sidelink synchronization signal block instance.

4. The method of claim 2, wherein the sidelink configuration defines an interval between starting times of consecutive sidelink synchronization signal block instances, wherein the interval allows for the multiple sidelink synchronization signal blocks to be included within a first sidelink synchronization signal block instance without overlapping a second sidelink synchronization signal block instance of the consecutive sidelink synchronization signal block instances.

5. The method of claim 2, wherein the sidelink configuration indicating that the multiple sidelink synchronization signal blocks are to transmitted within the sidelink synchronization signal block instance is indicative that the multiple sidelink synchronization signal blocks are to be transmitted back-to-back.

6. The method of claim 1, wherein receiving the message indicating that the first UE is to transmit multiple sidelink synchronization signal blocks within the sidelink synchronization signal block period comprises:
receiving an indication of a sidelink configuration, the sidelink configuration indicating that the first UE is to transmit the multiple sidelink synchronization signal blocks within a corresponding multiple sidelink synchronization signal block instances of the sidelink synchronization signal block period.

7. The method of claim 1, wherein transmitting the multiple sidelink synchronization signal blocks comprises:
transmitting the multiple sidelink synchronization signal blocks back-to-back within the sidelink synchronization signal block period.

8. The method of claim 7, wherein determining the one or more listen-before-talk occasions further comprises:
identifying a first listen-before-talk occasion associated with a temporally first of the multiple sidelink synchronization signal blocks, wherein the at least one listen-before-talk occasion during which the first UE participates in the listen-to-talk procedure is the first listen-before-talk occasion, the transmitting of the multiple sidelink synchronization signal blocks based at least in part on the first UE participating in the listen-before-talk procedure during only the first listen-before-talk occasion.

9. The method of claim 7, wherein determining the one or more listen-before-talk occasions further comprises:
identifying a first listen-before-talk occasion associated with a temporally first of the multiple sidelink synchronization signal blocks, wherein the first UE participates in an unsuccessful listen-before-talk procedure during the first listen-before-talk occasion; and
identifying one or more additional listen-before-talk occasions that temporally follow the first listen-before-talk occasion, wherein the at least one listen-before-talk occasion during which the first UE participates in the listen-to-talk procedure includes one of the one or more additional listen-before-talk occasions after also participating in the unsuccessful listen-before-talk procedure.

10. The method of claim 9, further comprising:
determining, based at least in part on the message, a quantity of the multiple sidelink synchronization signal blocks for transmission, wherein less than the quantity is transmitted based at least in part on the first UE participating in the unsuccessful listen-before-talk procedure during the first listen-before-talk occasion.

11. The method of claim 7, further comprising:
determining that one or more automatic gain control or gap symbols are during a transmission interval for the multiple sidelink synchronization signal blocks; and
transmitting a sidelink broadcast channel during the one or more automatic gain control or gap symbols based at least in part on the multiple sidelink synchronization signal blocks being transmitted back-to-back.

12. The method of claim 11, wherein transmitting the sidelink broadcast channel comprises:
transmitting the sidelink broadcast channel during a gap symbol by including resource elements of the gap symbol in rate matching or by duplicating a previously transmitted sidelink broadcast channel.

13. The method of claim 1, wherein transmitting the multiple sidelink synchronization signal blocks comprises:
transmitting the multiple sidelink synchronization signal blocks with the offset between consecutive ones of the multiple sidelink synchronization signal blocks.

14. The method of claim 13, wherein determining the one or more listen-before-talk occasions further comprises:
identifying a plurality of listen-before-talk occasions, each associated with one of the multiple sidelink synchronization signal blocks, the transmitting of the multiple sidelink synchronization signal blocks based at least in part on the first UE participating in the listen-before-talk procedure during multiple ones of the plurality of listen-before-talk occasions.

15. The method of claim 1, further comprising:
extending a first bandwidth of a primary synchronization signal of a sidelink synchronization signal block, a second bandwidth of a secondary synchronization signal of one or more of the multiple sidelink synchronization signal blocks, and a third bandwidth of a sidelink broadcast channel of the sidelink synchronization signal block within a sidelink bandwidth part based at least in part on lowering a coding rate, increasing a payload size, or both.

16. The method of claim 1, further comprising:
determining a power for transmitting the one or more sidelink synchronization signal blocks or a sidelink broadcast channel based at least in part on a quantity of resource blocks for transmitting the one or more sidelink synchronization signal blocks or the sidelink broadcast channel for an identified sub-carrier spacing configuration.

17. A method for wireless communication at a first user equipment (UE), comprising:
identifying, via a message, that a second UE is to transmit multiple sidelink synchronization signal blocks within a sidelink synchronization signal block period, the message also indicative of whether the multiple sidelink synchronization signal blocks are to be transmitted back-to-back or with an offset between consecutive ones of the multiple sidelink synchronization signal blocks;
monitoring for the multiple sidelink synchronization signal blocks transmitted by the second UE in accordance with the message; and
receiving, from the second UE, at least one of the multiple sidelink synchronization signal blocks.

18. The method of claim 17, wherein identifying that the second UE is to transmit multiple sidelink synchronization signal blocks within the sidelink synchronization signal block period comprises:
receiving an indication of a sidelink configuration, the sidelink configuration indicating that the second UE is to transmit the multiple sidelink synchronization signal blocks within a sidelink synchronization signal block instance of the sidelink synchronization signal block period.

19. The method of claim 17, wherein receiving at least one of the multiple sidelink synchronization signal blocks comprises:
blind detecting for the multiple sidelink synchronization signal blocks; and
determining that a received signal is one of the multiple sidelink synchronization signal blocks based at least in part on a comparison of a correlation energy of the received signal with a threshold.

20. A method for wireless communication at a first user equipment (UE), comprising:
identifying a reference frequency position of a reference sidelink synchronization signal block in a sidelink bandwidth part;
transmitting, to a second UE, the reference sidelink synchronization signal block in accordance with the reference frequency position; and
transmitting, to the second UE, one or more additional sidelink synchronization signal blocks whose frequency positions are different from but based at least in part on the reference frequency position.

21. The method of claim 20, further comprising:
receiving, from a network entity, a message indicating the reference frequency position of the reference sidelink synchronization signal block in the sidelink bandwidth part.

22. The method of claim 20, wherein transmitting the one or more additional sidelink synchronization signal blocks comprises:
transmitting the one or more additional sidelink synchronization signal blocks whose frequency positions are different from but based at least in part on the reference frequency position, wherein the one or more additional sidelink synchronization signal blocks are continuous in frequency.

23. The method of claim 22, further comprising:
receiving, from a network entity, signaling indicating a sub-carrier spacing configuration, the sub-carrier spacing configuration indicative of a quantity of sidelink synchronization signal blocks to be transmitted in the sidelink bandwidth part by the first UE, the sidelink synchronization signal blocks comprising the reference sidelink synchronization signal block and the one or more additional sidelink synchronization signal blocks; and
identifying the quantity of sidelink synchronization signal blocks to be transmitted in the sidelink bandwidth part by the first UE based at least in part on receiving the signaling.

24. The method of claim 22, further comprising:
receiving, from a network entity, signaling indicating a quantity of sidelink synchronization signal blocks to be transmitted in the sidelink bandwidth part by the first UE, the sidelink synchronization signal blocks comprising the reference sidelink synchronization signal block and the one or more additional sidelink synchronization signal blocks.

25. The method of claim 22, further comprising:
identifying a quantity of sidelink synchronization signal blocks to be transmitted in the sidelink bandwidth part by the first UE, wherein the quantity of sidelink synchronization signal blocks is pre-configured, and wherein the sidelink synchronization signal blocks comprise the reference sidelink synchronization signal block and the one or more additional sidelink synchronization signal blocks.

26. The method of claim 20, wherein transmitting the one or more additional sidelink synchronization signal blocks comprises:
transmitting the one or more additional sidelink synchronization signal blocks whose frequency positions are different from but based at least in part on the reference frequency position, wherein the one or more additional sidelink synchronization signal blocks are at least partially discontinuous in frequency.

27. The method of claim 26, wherein a quantity of sidelink synchronization signal blocks is based at least in part on a mode of the first UE, wherein the mode comprises a low power indoor mode or a very low power mode, and wherein the sidelink synchronization signal blocks comprise the reference sidelink synchronization signal blocks and the one or more additional sidelink synchronization signal blocks.

28. The method of claim 26, further comprising:
receiving, from a network entity, signaling indicating a bitmap indicative of a quantity of sidelink synchronization signal blocks to be transmitted in the sidelink bandwidth part by the first UE, the sidelink synchronization signal blocks comprising the reference sidelink synchronization signal block and the one or more additional sidelink synchronization signal blocks, and wherein a first bit of the bitmap corresponds to the reference sidelink synchronization signal block.

29. A method for wireless communication at a first user equipment (UE), comprising:
identifying a reference frequency position of a reference sidelink synchronization signal block in a sidelink bandwidth part;
receiving, from a second UE, the reference sidelink synchronization signal block in accordance with the reference frequency position; and
receiving, from the second UE, one or more additional sidelink synchronization signal blocks whose frequency positions are different from but based at least in part on the reference frequency position.

30. The method of claim 29, further comprising:
decoding the one or more additional sidelink synchronization signal blocks to identify pseudo-noise sequence-based scrambling added to each sidelink synchronization signal block of the one or more additional sidelink synchronization signal blocks, wherein a pseudo-noise sequence of the pseudo-noise sequence-based scrambling is different for each sidelink synchronization signal block of the one or more additional sidelink synchronization signal blocks.
